(19) United States
(12) Patent Application Publication
(10) Pub. No.: US 2026/0204592 A1
(43) Pub. Date: Jul. 16, 2026

(54) CATHODE FOR ALL-SOLID SECONDARY BATTERY, ALL-SOLID SECONDARY BATTERY INCLUDING CATHODE, AND METHOD OF PREPARING ALL-SOLID SECODARY BATTERY

(71) Applicant: Samsung SDI Co., Ltd., Yongin-si (KR)

(72) Inventors: Wonsung Choi, Suwon-si (KR); Dongil Kang, Suwon-si (KR); Mokwon Kim, Suwon-si (KR); Seungsik Hwang, Suwon-si (KR)

(21) Appl. No.: 19/443,158

(22) Filed: Jan. 8, 2026

(30) Foreign Application Priority Data
Jan. 14, 2025 (KR) 10-2025-0005601

(51) Int. Cl. H01M 4/78; H01M 4/02; H01M 4/04; H01M 10/0525; H01M 10/0585

(52) U.S. Cl. CPC H01M 4/78; H01M 4/0435; H01M 10/0525; H01M 10/0585; H01M 2004/021; H01M 2004/028

(57) ABSTRACT

A cathode for an all-solid secondary battery, an all-solid secondary battery including the cathode, and a method of preparing an all-solid secondary battery. The cathode includes a cathode current collector and a cathode active material layer containing a solid electrolyte, on the cathode current collector, where the cathode current collector includes a first surface adjacent to the cathode active material layer, and a second surface opposing the first surface, and the second surface of the cathode current collector has a highest surface roughness value of 1.5 micrometers or more.

### CROSS-REFERENCE TO RELATED APPLICATION

This application is based on and claims priority to Korean Patent Application No. 10-2025-0005601, filed on Jan. 14, 2025, in the Korean Intellectual Property Office, and all the benefits accruing therefrom under 35 USC § 119, the content of which is incorporated by reference herein in its entirety.

### BACKGROUND

### 1. Field

The disclosure relates to a cathode for an all-solid secondary battery, an all-solid secondary battery including the cathode, and a method of preparing an all-solid secondary battery.

### 2. Description of the Related Art

Recently, there has been active development of batteries that provide increased energy density and safety. Lithium batteries are used in information devices, communication devices, automobiles, and the like. Since automobiles directly affect human lives, safety is of utmost importance. Lithium batteries containing liquid electrolytes include flammable organic solvents. Lithium batteries with liquid electrolytes have a high risk of overheating and fire in the event of a short circuit. Compared to liquid electrolytes, solid electrolytes have a reduced risk of overheating and fire in the event of a short circuit. Lithium batteries containing solid electrolytes may provide improved safety as compared to lithium batteries containing liquid electrolytes.

### SUMMARY

Provided is a cathode for an all-solid secondary battery having reduced porosity by being uniformly pressurized.

Provided is an all-solid secondary battery having reduced internal resistance and improved charge-discharge characteristics by including a cathode with reduced porosity.

Provided is a method of preparing an all-solid secondary battery that enables uniform pressurization of a cathode.

Additional aspects will be set forth in part in the description which follows and, in part, will be apparent from the description, or may be learned by practice of the presented embodiments of the disclosure.

According to an aspect of the disclosure, a cathode for an all-solid secondary battery includes a cathode current collector and a cathode active material layer including a solid electrolyte on the cathode current collector, where the cathode current collector includes a first surface adjacent to the cathode active material layer and a second surface opposing the first surface, and the highest surface roughness value R_{y2} of the second surface of the cathode current collector is 1.5 micrometers (μm) or more.

According to another aspect of the disclosure, an all-solid secondary battery includes the aforementioned cathode, an anode, and a solid electrolyte layer between the cathode and the anode, where the solid electrolyte layer includes a first solid electrolyte layer disposed adjacent to the cathode and an second solid electrolyte layer disposed adjacent to the anode, and the porosity of the first solid electrolyte layer is lower than the porosity of the second solid electrolyte layer.

According to another aspect of the disclosure, a method of preparing an all-solid secondary battery includes applying a first pressurization to a cathode and a solid electrolyte layer together with a first pressurization auxiliary layer to prepare a cathode-solid electrolyte layer laminate, and applying a second pressurization to the cathode-solid electrolyte layer laminate and an anode-solid electrolyte layer laminate together with a second pressurization auxiliary layer to prepare the all-solid secondary battery.

According to another aspect of the disclosure, a method of preparing a cathode includes pressurizing a cathode together with a pressurization auxiliary layer.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional schematic diagram of a cathode for an all-solid secondary battery according to an embodiment;

FIG. 2 is a cross-sectional schematic diagram of a cathode for an all-solid secondary battery according to the prior art:

FIG. 3 is a cross-sectional schematic diagram of a cathode for an all-solid secondary battery according to an embodiment;

FIG. 4 is a cross-sectional schematic diagram of an all-solid secondary battery according to an embodiment;

FIG. 5A is a cross-sectional schematic diagram of a cathode used in a method of preparing an all-solid secondary battery according to an embodiment;

FIG. 5B is a cross-sectional schematic diagram of a solid electrolyte layer/protective layer laminate used in a method of preparing an all-solid secondary battery according to an embodiment;

FIG. 5C is a cross-sectional schematic diagram of a first pressurization process used in a method of preparing all-solid secondary battery according to an embodiment;

FIG. 5D is a cross-sectional schematic diagram of a cathode-solid electrolyte laminate used in a method of preparing an all-solid secondary battery according to an embodiment;

FIG. 6A is a cross-sectional schematic diagram of an anode used in a method of preparing an all-solid secondary battery according to an embodiment;

FIG. 6B is a cross-sectional schematic diagram of a solid electrolyte layer/protective layer laminate used in a method of preparing an all-solid secondary battery according to an embodiment;

FIG. 6C is a cross-sectional schematic diagram of a first pressurization process used in a method for preparing an all-solid secondary battery according to an embodiment;

FIG. 6D is a cross-sectional schematic diagram of an anode-solid electrolyte laminate used in a method of preparing an all-solid secondary battery according to an embodiment;

FIG. 7A is a cross-sectional schematic diagram of a second pressurization process used in a method of preparing an all-solid secondary battery according to an embodiment;

FIG. 7B is a cross-sectional schematic diagram of an all-solid secondary battery prepared by a preparing method according to an embodiment;

FIG. 8 shows thickness (micrometers, μm) versus distance (micrometers, μm) of surface profiles of second surfaces of cathode current collectors of all-solid secondary batteries prepared in Example 1 and Comparative Example 1;

FIG. 9 is a scanning electron microscope image of a cross-section of a cathode of an all-solid secondary battery prepared in Example 4; and

FIG. 10 is a scanning electron microscope image of a cross-section of the cathode of the all-solid secondary battery prepared in Comparative Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Various embodiments have been illustrated in the attached drawings. However, the inventive concept may be embodied in many other forms, and should not be construed as limited to the embodiments described herein. Rather, these embodiments are provided so that the disclosure may be thorough and complete and to fully convey the scope of the inventive concept to those skilled in the art. The same reference numerals refer to the same components.

It may be understood that when an element is referred to as being “on” another element, it may be directly on top of the other element, or there may be other elements intervening between them. In contrast, when an element is said to be “directly on” another element, there are no intervening elements between them.

Terms such as “first,” “second,” and “third” may be used herein to describe various components, ingredients, regions, layers, and/or zones, but are not limited by these terms. These terms are used only to distinguish one component, ingredient, region, layer or zone from another component, ingredient, region, layer or zone. Accordingly, a first component, ingredient, region, layer or zone described below may be referred to as a second component, ingredient, region, layer or zone without departing from the teachings of this disclosure.

The terminology used herein is for the purpose of describing particular embodiments only and is not intended to limit the inventive concept. As used herein, the singular forms “a,” “an,” and “the” are intended to include the plural forms, including “at least one,” unless the context clearly dictates otherwise. The wording “at least one” should not be construed as limited to being singular, i.e., includes a combination thereof.

As used herein, the term “and/or” includes any and all combinations of one or more of the listed items. When used in the detailed description, the terms “includes” and/or “including” specify the presence of the stated features, regions, integers, steps, operations, elements, components and/or ingredients, but do not preclude the presence or addition of one or more other features, regions, integers, steps, operations, elements, components and/or groups thereof.

Spatially relative terms such as “beneath,” “below,” “lower,” “above,” “upper,” or the like may be used herein for ease of description to describe one element or feature's relationship to another element or feature. It will be understood that spatially relative terms are intended to encompass different orientations of the device in use or operation in addition to the orientation depicted in the drawings. For example, if the device in the drawings is turned over, elements described as “beneath” or “below” other elements or features would then be oriented “above” the other elements or features. Accordingly, the exemplary term “below” may encompass both an orientation of above and below. The device may be otherwise oriented (rotated 90 degrees or at other orientations) and the spatially relative terms used herein may be interpreted accordingly.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) as used herein have the same meaning as commonly understood by one of ordinary skill in the art to which this disclosure belongs. Additionally, terms defined in commonly used dictionaries should be interpreted as having a meaning consistent with their meaning within the context of the relevant art and the disclosure, and not in an idealized or overly formal sense.

Embodiments are described in the disclosure with reference to cross-sectional views of idealized embodiments. For example, variations from the shape of the drawing may be expected as a result of manufacturing techniques and/or tolerances. Therefore, the embodiments described in the disclosure should not be construed as being limited to the specific shapes of regions as depicted in the drawings of the disclosure, but should include, for example, deviations in shapes resulting from manufacturing. For example, regions illustrated or described as being flat may be rough and/or include nonlinear features. Moreover, the sharply illustrated angles may be rounded. Accordingly, the regions depicted in the drawings are inherently schematic, and their shapes are not intended to depict the precise shape of the regions or to limit the scope of the disclosure.

“Group” means a group of the Periodic Table of the Elements according to the International Union of Pure and Applied Chemistry (“IUPAC”) Group 1-18 classification system.

As used herein, the “particle diameter” indicates an average diameter of the particle when the particle is spherical, and indicates an average major axis length of the particle when the particle is non-spherical. The particle diameter of the particles may be measured using a particle size analyzer (PSA). The “particle diameter” is, for example, an average particle diameter. The “average particle diameter” is, for example, the median particle diameter (D50).

As used herein, “D50” refers to the particle size corresponding to 50% cumulative volume, calculated from the smaller particle size side in the particle size distribution measured by laser diffraction.

As used herein, “D90” refers to the particle size corresponding to 90% cumulative volume, calculated from the smaller particle size side in the particle size distribution measured by laser diffraction.

As used herein, “D10” refers to the particle size corresponding to 10% cumulative volume, calculated from the smaller particle size side in the particle size distribution measured by laser diffraction.

As used herein, “metal” includes both metals and metalloids such as silicon and germanium, in elemental or ionic states.

As used herein, “alloy” means a mixture of two or more metals.

As used herein, “electrode active material” refers to an electrode material capable of undergoing lithiation and delithiation.

As used herein, “cathode active material” refers to a cathode material capable of undergoing lithiation and delithiation.

As used herein, “anode active material” refers to an anode material capable of undergoing lithiation and delithiation.

As used herein, “lithiation” and “to lithiate” refers to a process of adding lithium to an electrode active material.

As used herein, “delithiation” and “to delithiate” refers to a process of removing lithium from an electrode active material.

As used herein, “charging” and “to charge” refers to a process of providing electrochemical energy to a battery.

As used herein, “discharging” and “to discharge” refers to a process of removing electrochemical energy from a battery.

As used herein, “positive electrode” and “cathode” refer to an electrode at which electrochemical reduction and lithiation occur during a discharge process.

As used herein, “negative electrode” and “anode” refer to an electrode at which electrochemical oxidation and delithiation occur during a discharge process.

Although specific embodiments have been described, alternatives, modifications, variations, improvements, and substantial equivalents that may not currently be anticipated or foreseeable could arise for the applicant or those skilled in the art.

Therefore, the appended claims, as filed and as amended, are intended to encompass all such alternatives, modifications, variations, improvements, and substantial equivalents.

Hereinafter, a lithium ion conductor according to embodiments and a lithium battery including the same are described in more detail.

### Cathode

A cathode for an all-solid secondary battery according to an embodiment includes a cathode current collector and a cathode active material layer containing a solid electrolyte on the cathode current collector. The cathode current collector includes a first surface adjacent to the cathode active material layer and a second surface opposing the first surface. The highest surface roughness value R_{y2} of the second surface of the cathode current collector is 1.5 μm or more.

By arranging a flexible pressurization auxiliary layer on a cathode current collector during pressurization for preparing a cathode for an all-solid secondary battery, pressure may be uniformly transmitted along the surface contour of the cathode active material layer. For example, more pressure may be distributed and transmitted to the solid electrolyte between the cathode active material particles that constitute the cathode active material layer. The pressure-assisted sintering of the solid electrolyte disposed between the cathode active material particles is promoted, thereby reducing the voids between the cathode active material particles, thereby decreasing the porosity of the cathode active material layer, lowering the internal resistance of an all-solid secondary battery including such a cathode, and improving its cycle characteristics. In addition, by arranging a flexible pressurization auxiliary layer on the cathode current collector during pressurization for preparing a cathode for an all-solid secondary battery, pressure may be uniformly transmitted to the cathode current collector along the surface contour of the cathode active material layer. Accordingly, the surface contour of the cathode active material layer is transferred to the first surface adjacent to the cathode active material layer and the second surface opposite to the first surface, and the highest surface roughness value R_{y} of the second surface increases to 1.5 μm or more. The highest surface roughness value R_{y2} refers to a difference between the highest peak and the lowest valley in the surface profile measured for the second surface. In contrast, when applying a pressure to prepare a conventional cathode for all-solid secondary battery, the pressure is preferentially transmitted to the cathode active material particles by disposing a high-strength substrate, and the pressure is partially transmitted to the solid electrolyte between the cathode active material particles. This leads to insufficient pressure-assisted sintering of the solid electrolyte situated between the active material particles, increasing the voids between the particles, thereby raising the porosity of the cathode active material layer, increasing the internal resistance of the all-solid secondary battery, and deteriorating its cycle characteristics.

### Cathode Current Collector

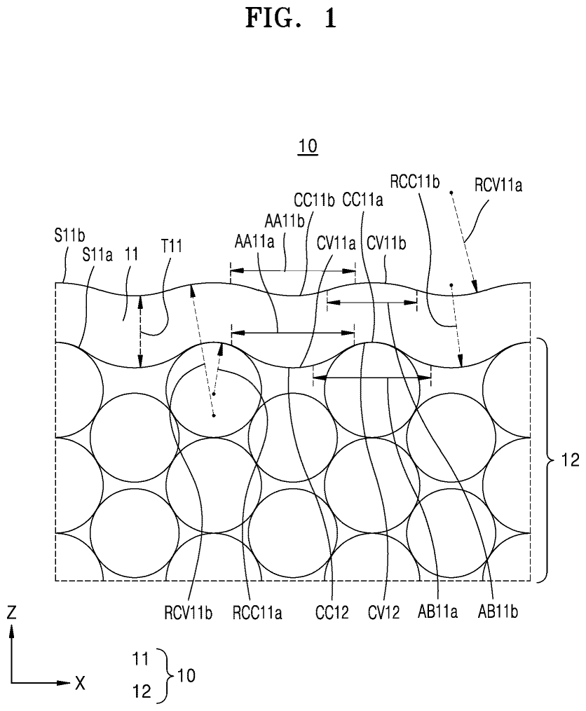

FIG. 1 is a cross-sectional schematic diagram of a cathode for an all-solid secondary battery according to an embodiment. In FIG. 1, the spherical particles of the cathode active material layer 12 are cathode active material particles, and a solid electrolyte is placed between the cathode active material particles.

Referring to FIG. 1, a cathode 10 for an all-solid secondary battery includes a cathode current collector 11 and a cathode active material layer 12 containing a solid electrolyte on the cathode current collector 11. The cathode current collector 11 includes a first surface S11a adjacent to the cathode active material layer 12 and a second surface S11b opposing the first surface S11a.

The highest surface roughness value R_{y} of the second surface S11b of the cathode current collector may be, for example, 1.5 μm or more, 2 μm or more, 2.5 μm or more, 3 μm or more, or 3.5 μm or more. The highest surface roughness value R_{y} of the second surface S11b of the cathode current collector may be, for example, 10 μm or less, 9 μm or less, 8 μm or less, or 7 μm or less. The highest surface roughness value R_{y} of the second surface S11b of the cathode current collector may be, for example, about 1.5 μm to about 10 μm, about 2 μm to about 9 μm, about 2.5 μm to about 8 μm, about 3 μm to about 7 μm, or about 3.5 μm to about 7 μm. By having the highest surface roughness value R_{y} of the second surface S11b of the cathode current collector within this range, the porosity of the cathode active material layer 12 may be more effectively reduced.

The internal resistance of an all-solid secondary battery 100 including such cathode 10 may be reduced and the cycle characteristics may be improved. The highest surface roughness value R_{y} of the second surface S11b of the cathode current collector may be measured, for example, using an optical microscope, a scanning electron microscope, or the like. For example, the second surface S11b of the cathode current collector may be observed using an optical microscope to obtain the surface roughness profile of the cathode current collector, and the highest surface roughness value may be measured from this profile. Alternatively, the highest surface roughness value of the second surface S11b of the cathode current collector may be measured by measuring the surface profile of the cross-section of the cathode 10 using a scanning electron microscope.

The highest surface roughness value R_{y1} of the first surface S11a of the cathode current collector may be, for example, 1.0 μm or more, 1.5 μm or more, 2 μm or more, 2.5 μm or more, or 3 μm or more. The highest surface roughness value R_{y1} of the first surface S11a of the cathode current collector may be, for example, 10 μm or less, 9 μm or less, 8 μm or less, or 7 μm or less. The highest surface roughness value R_{y1} of the first surface S11a of the cathode current collector may be, for example, about 1.0 μm to about 10 μm, about 1.5 μm to about 9 μm, about 2 μm to about 8 μm, about 2.5 μm to about 7 μm or about 3 μm to about 7 μm. By having the highest surface roughness value R_{y1} of the first surface S11a of the cathode current collector within this range, the porosity of the cathode active material layer 12 may be more effectively reduced. The highest surface roughness value R_{y1} of the first surface S11a of the cathode current collector may be measured, for example, using an optical microscope, a scanning electron microscope, or the like. For example, the highest surface roughness value of the first surface S11a of the cathode current collector may be measured by measuring the surface profile of the cross-section of the cathode 10 using a scanning electron microscope. Alternatively, the cathode active material layer 12 is removed from the cathode 10 and the first surface S11a of the cathode current collector is observed using an optical microscope to derive a roughness profile of the surface of the cathode current collector, from which the highest surface roughness value of the first surface S11a of the cathode current collector may be measured. The internal resistance of an all-solid secondary battery 100 including such cathode 10 may be reduced and the cycle characteristics may be improved.

The highest surface roughness value R_{y2} of the second surface S11b of the cathode current collector may be, for example, 15% or more, 20% or more, or 25% or more of the thickness T11 of the cathode current collector. The highest surface roughness value R_{y2} of the second surface S11b of the cathode current collector may be, for example, 60% or less, 55% or less, or 50% or less of the thickness T11 of the cathode current collector. The highest surface roughness value R_{y2} of the second surface S11b of the cathode current collector may be, for example, about 15% to about 60%, about 20% to about 55% or about 25% to about 50% of the thickness T11 of the cathode current collector. By having the highest surface roughness value R_{y2} of the second surface S11b of the cathode current collector within this range, the porosity of the cathode active material layer 12 may be more effectively reduced. The thickness of the cathode current collector T11 may be the average thickness of the cathode current collector. The average thickness of the cathode current collector may be the average value of the vertical distances between the first surface and the second surface measured at 10 selected points across the entire cathode current collector. The internal resistance of an all-solid secondary battery 100 including such cathode 10 may be reduced and the cycle characteristics may be improved.

The highest surface roughness value R_{y1} of the first surface S11a of the cathode current collector may be, for example, 5% or more, 10% or more, or 15% or more of the thickness T11 of the cathode current collector. The highest surface roughness value R_{y1} of the first surface S11a of the cathode current collector may be, for example, 70% or less, 65% or less, or 60% or less of the thickness T11 of the cathode current collector. The highest surface roughness value R_{y1} of the first surface S11a of the cathode current collector may be, for example, about 5% to about 70%, about 10% to about 65% or about 15% to about 60% of the thickness T11 of the cathode current collector. By having the highest surface roughness value R_{y1} of the first surface S11a of the cathode current collector within this range, the porosity of the cathode active material layer 12 may be more effectively reduced. The thickness of the cathode current collector T11 may be the average thickness of the cathode current collector. The average thickness of the cathode current collector may be the average value of the vertical distances between the first surface and the second surface measured at 10 selected points across the entire cathode current collector. The internal resistance of an all-solid secondary battery 100 including such cathode 10 may be reduced and the cycle characteristics may be improved.

The highest surface roughness value R_{y1} of the first surface S11a of the cathode current collector may be greater than the highest surface roughness value R_{y2} of the second surface S11b of the cathode current collector. The ratio R_{y1}/R_{y2} of the highest surface roughness value R_{y} of the first surface S11a of the cathode current collector and the highest surface roughness value R_{y} of the second surface S11b of the cathode current collector may be, for example, 1.01 or more, 1.05 or more, or 1.10 or more. The ratio R_{y1}/R_{y2} of the highest surface roughness value R_{y} of the first surface S11a of the cathode current collector and the highest surface roughness value R_{y} of the second surface S11b of the cathode current collector may be, for example, 2 or less, 1.5 or less, or 1.3 or less. The ratio R_{y1}/R_{y2} of the highest surface roughness value R_{y} of the first surface S11a of the cathode current collector to the highest surface roughness value R_{y} of the second surface S11b of the cathode current collector may be, for example, about 1.01 to about 2, about 1.05 to about 1.5, or about 1.10 to about 1.3. By having the ratio R_{y1}/R_{y2} of the highest surface roughness value R_{y} of the first surface S11a of the cathode current collector and the highest surface roughness value R_{y} of the second surface S11b of the cathode current collector within this range, the porosity of the cathode active material layer 12 may be more effectively reduced. The internal resistance of an all-solid secondary battery 100 including such cathode 10 may be reduced and the cycle characteristics may be improved.

The thickness T11 of the cathode current collector may be, for example, about 2 μm to about 100 μm, about 4 μm to about 50 μm, about 5 μm to about 30 μm, or about 5 μm to about 20 μm. By having the thickness of the cathode current collector 11 within this range, the porosity of the cathode active material layer 12 may be more effectively reduced. The internal resistance of an all-solid secondary battery 100 including such cathode 10 may be reduced and the cycle characteristics may be improved. The cathode current collector 11 may include, for example, aluminum (Al), indium (In), copper (Cu), magnesium (Mg), stainless steel, titanium (Ti), iron (Fe), cobalt (Co), nickel (Ni), zinc (Zn), germanium (Ge), lithium (Li), or an alloy thereof.

The first surface S11a of the cathode current collector and the second surface S11b of the cathode current collector may each include, for example, an uneven surface including a convex portion and a concave portion, respectively. The first surface S11a of the cathode current collector and the second surface S11b of the cathode current collector may have an uneven surface including, for example, a convex portion and a concave portion, respectively, so that the porosity of the cathode active material layer 12 may be reduced more effectively. The internal resistance of an all-solid secondary battery 100 including such cathode 10 may be reduced and the cycle characteristics may be improved.

The cathode active material layer 12 may have, for example, a cathode active material layer concave portion CC12. The first surface S11a of the cathode current collector may have a cathode current collector convex portion CV11a that protrudes toward the cathode active material layer 12 corresponding to the cathode active material layer concave portion CC12. The second surface S11b of the cathode current collector may have a cathode current collector concave portion CC11b that is recessed in the direction of the cathode active material layer 12 corresponding to the cathode current collector convex portion CV11a.

In the thickness direction of the cathode current collector (i.e., in the z direction), at least a portion of an area AA11a occupied by the cathode current collector convex portion CV11a of the first surface S11a of the cathode current collector may overlap with at least a portion of an area AA11b occupied by the cathode current collector concave portion CC11b of the second surface S11b of the cathode current collector. By having at least a portion of the area AA11a occupied by the cathode current collector convex portion CV11a of the first surface S11a of the cathode current collector overlap with at least a portion of the area AA11b occupied by the cathode current collector concave portion CC11b of the second surface S11b of the cathode current collector, the porosity of the cathode active material layer 12 may be more effectively reduced. The internal resistance of an all-solid secondary battery 100 including such cathode 10 may be reduced and the cycle characteristics may be improved. The area AA11a occupied by the cathode current collector convex portion CV11a of the first surface S11a of the cathode current collector is, for example, the area occupied by the cathode current collector convex portion CV11a in the plan view of the cathode current collector. The area AA11b occupied by the cathode current collector concave portion CC11b of the second surface S11b of the cathode current collector is, for example, the area occupied by the cathode current collector concave portion CC11b in the plan view of the cathode current collector.

The cross-sectional shape of the cathode current collector concave portion CC11b of the second surface S11b of the cathode current collector may correspond, for example, to the cross-sectional shape of the cathode current collector convex portion CV11a of the first surface S11a of the cathode current collector. The cross-sectional shape of the cathode current collector concave portion CC11b of the second surface S11b of the cathode current collector may have, for example, a shape in which the cathode current collector convex portion CV11a of the first surface S11a of the cathode current collector is transferred. The cross-sectional shape of the cathode current collector concave portion CC11b of the second surface S11b of the cathode current collector may have, for example, a shape similar to or identical to the cross-sectional shape of the cathode current collector convex portion CV11a of the first surface S11a of the cathode current collector. By having the cross-sectional shape of the cathode current collector concave portion CC11b of the second surface S11b of the cathode current collector correspond to the cross-sectional shape of the cathode current collector convex portion CV11a of the first surface S11a of the cathode current collector, the porosity of the cathode active material layer 12 may be more effectively reduced. The internal resistance of an all-solid secondary battery 100 including such cathode 10 may be reduced and the cycle characteristics may be improved.

The radius of curvature RCC11b of the cross-section of the cathode current collector concave portion of the second surface S11b of the cathode current collector may be larger than the radius of curvature RCV11a of the cross-section of the cathode current collector convex portion of the first surface S11a of the cathode current collector. The ratio RCC11b/RCV11a of the radius of curvature RCC11b of the cross-section of the cathode current collector concave portion of the second surface S11b of the cathode current collector and the radius of curvature RCV11a of the cross-section of the cathode current collector convex portion of the first surface S11a of the cathode current collector may be, for example, greater than 1.0, 1.1 or more, 1.5 or more, or 2 or more. The ratio RCC11b/RCV11a of the radius of curvature RCC11b of the cross-section of the cathode current collector concave portion of the second surface S11b of the cathode current collector and the radius of curvature RCV11a of the cross-section of the cathode current collector convex portion of the first surface S11a of the cathode current collector may be, for example, 100 or less, 50 or less, 20 or less, or 10 or less. The ratio RCC11b/RCV11a of the radius of curvature RCC11b of the cross-section of the cathode current collector concave portion of the second surface S11b of the cathode current collector and the radius of curvature RCV11a of the cross-section of the cathode current collector convex portion of the first surface S11a of the cathode current collector may be, for example, greater than about 1.0 to about 100, about 1.1 to about 50, about 1.5 to about 20, or about 2 to about 10. By having the ratio RCC11b/RCV11a of the radius of curvature RCC11b of the cross-section of the cathode current collector concave portion of the second surface S11b of the cathode current collector and the radius of curvature RCV11a of the cross-section of the cathode current collector convex portion of the first surface S11a of the cathode current collector within this range, the porosity of the cathode active material layer 12 may be more effectively reduced. The internal resistance of an all-solid secondary battery 100 including such cathode 10 may be reduced and the cycle characteristics may be improved.

The radius of curvature RCC11b of the cross-section of the cathode current collector concave portion of the second surface S11b of the cathode current collector may be, for example, 1000 μm or less, 500 μm or less, 100 μm or less, 50 μm or less, or 10 μm or less. The radius of curvature RCC11b of the cross-section of the cathode current collector concave portion of the second surface S11b of the cathode current collector may be, for example, about 1 μm to about 1000 μm, about 1 μm to about 500 μm, about 1 μm to about 100 μm, about 1 μm to about 50 μm or less, or about 1 μm to about 10 μm. By having the radius of curvature RCC11b of the cross-section of the cathode current collector concave portion of the second surface S11b of the cathode current collector within this range, the porosity of the cathode active material layer 12 may be more effectively reduced. The internal resistance of an all-solid secondary battery 100 including such cathode 10 may be reduced and the cycle characteristics may be improved.

The radius of curvature RCV11a of the cross-section of the cathode current collector convex portion of the first surface S11a of the cathode current collector may be, for example, 900 μm or less, 500 μm or less, 100 μm or less, 50 μm or less, or 10 μm or less. The radius of curvature RCV11a of the cross-section of the first cathode current collector protrusion of the first surface S11a of the cathode current collector may be, for example, about 1 μm to about 900 μm, about 1 μm to about 500 μm, about 1 μm to about 100 μm, about 1 μm to about 50 μm or less, or about 1 μm to about 10 μm. By having the radius of curvature RCV11a of the cross-section of the cathode current collector convex portion of the first surface S11a of the cathode current collector within this range, the porosity of the cathode active material layer 12 may be more effectively reduced. The internal resistance of an all-solid secondary battery 100 including such cathode 10 may be reduced and the cycle characteristics may be improved.

The cathode active material layer 12 may have, for example, a cathode active material layer convex portion CV12. The first surface S11a of the cathode current collector may have a another cathode current collector concave portion CC11a that is recessed in the direction of the cathode active material layer 12 corresponding to the cathode active material layer convex portion CV12. The second surface S11b of the cathode current collector may have a another cathode current collector convex portion CV11b that protrudes toward the cathode active material layer 12 corresponding to the another cathode current collector concave portion CC11a.

In the thickness direction of the cathode current collector (i.e., in the z direction), at least a part of an area AB11a occupied by the another cathode current collector concave portion CC11a of the first surface S11a of the cathode current collector may overlap with at least a part of an area AB11b occupied by the another cathode current collector convex portion CC11a of the second surface S11b of the cathode current collector. By having at least a portion of the area AB11a occupied by the another cathode current collector concave portion CC11a of the first surface S11a of the cathode current collector overlap with at least a portion of the area AB11b occupied by the another cathode current collector convex portion CV11b of the second surface S11b of the cathode current collector, the porosity of the cathode active material layer 12 may be more effectively reduced. The internal resistance of an all-solid secondary battery 100 including such cathode 10 may be reduced and the cycle characteristics may be improved.

The area AB11a occupied by the another cathode current collector concave portion CC11a of the first surface S11a of the cathode current collector is, for example, the area occupied by the another cathode current collector concave portion CC11a in the plan view of the cathode current collector. The area AB11b occupied by the another cathode current collector convex portion CV11b of the second surface S11b of the cathode current collector is, for example, the area occupied by the another cathode current collector convex portion CV11b in the plan view of the cathode current collector.

The cross-sectional shape of the another cathode current collector convex portion CV11b of the second surface S11b of the cathode current collector may correspond, for example, to the cross-sectional shape of the another cathode current collector concave portion CCV11a of the first surface S11a of the cathode current collector. The cross-sectional shape of the another cathode current collector convex portion CVC11b of the second surface S11b of cathode current collector may have, for example, a shape in which the another cathode current collector concave portion CC11a of the first surface S11a of the cathode current collector is transferred. The cross-sectional shape of the another cathode current collector convex portion CV11b of the second surface S11b of the cathode current collector may have, for example, a shape similar to or identical to the cross-sectional shape of the another cathode current collector concave portion CC11a of the first surface S11a of the cathode current collector. The porosity of the cathode active material layer 12 may be reduced more effectively by making the cross-sectional shape of the another cathode current collector convex portion CV11b of the second surface S11b of the cathode current collector correspond to the cross-sectional shape of the another cathode current collector concave portion CC11a of the first surface S11a of the cathode current collector. The internal resistance of an all-solid secondary battery 100 including such cathode 10 may be reduced and the cycle characteristics may be improved.

The radius of curvature RCV11b of the cross-section of the another cathode current collector convex portion of the second surface S11b of the cathode current collector may be larger than the radius of curvature RCC11a of the cross-section of the another cathode current collector concave portion of the first surface S11a of the cathode current collector. The ratio RCV11b/RCC11a of the radius of curvature RCV11b of the cross-section of the another cathode current collector convex portion of the second surface S11b of the cathode current collector and the radius of curvature RCC11a of the cross-section of the another cathode current collector concave portion of the first surface S11a of the cathode current collector may be, for example, greater than 1.0, 1.1 or more, 1.5 or more, or 2 or more. The ratio RCV11b/RCC11a of the radius of curvature RCV11b of the cross-section of the another cathode current collector convex portion of the second surface S11b of the cathode current collector and the radius of curvature RCC11a of the cross-section of the another cathode current collector concave portion of the first surface S11a of the cathode current collector may be, for example, 100 or less, 50 or less, 20 or less, or 10 or less. The ratio RCV11b/RCC11a of the radius of curvature RCV11b of the cross-section of the another cathode current collector convex portion of the second surface S11b of the cathode current collector and the radius of curvature RCC11a of the cross-section of the another cathode current collector concave portion of the first surface S11a of the cathode current collector may be, for example, greater than about 1.0 to about 100, about 1.1 to about 50, about 1.5 to about 20, or about 2 to about 10. By having the ratio RCV11b/RCC11a of the radius of curvature RCV11b of the cross-section of the another cathode current collector convex portion of the second surface S11b of the cathode current collector and the radius of curvature RCC11a of the cross-section of the another cathode current collector concave portion of the first surface S11a of the cathode current collector within this range, the porosity of the cathode active material layer 12 may be reduced more effectively. The internal resistance of an all-solid secondary battery 100 including such cathode 10 may be reduced and the cycle characteristics may be improved.

The radius of curvature RCV11b of the cross-section of the another cathode current collector convex portion of the second surface S11b of the cathode current collector may be, for example, 1000 μm or less, 500 μm or less, 100 μm or less, 50 μm or less, or 10 μm or less. The radius of curvature RCVC11b of the cross-section of the another cathode current collector convex portion of the second surface S11b of the cathode current collector may be, for example, about 1 μm to about 1000 μm, about 1 μm to about 500 μm, about 1 μm to about 100 μm, about 1 μm to about 50 μm or less, or about 1 μm to about 10 μm. By having the radius of curvature RCV11b of the cross-section of the another cathode current collector convex portion of the second surface S11b of the cathode current collector within this range, the porosity of the cathode active material layer 12 may be reduced more effectively. The internal resistance of an all-solid secondary battery 100 including such cathode 10 may be reduced and the cycle characteristics may be improved.

The radius of curvature RCC11a of the cross-section of the another cathode current collector concave portion of the first surface S11a of the cathode current collector may be, for example, 900 μm or less, 500 μm or less, 100 μm or less, 50 μm or less, or 10 μm or less. The radius of curvature RCCV11a of the cross-section of the another cathode current collector concave portion of the first surface S11a of the cathode current collector may be, for example, about 1 μm to about 900 μm, about 1 μm to about 500 μm, about 1 μm to about 100 μm, about 1 μm to about 50 μm or less, or about 1 μm to about 10 μm. By having the radius of curvature RCC11a of the cross-section of the another cathode current collector concave portion of the first surface S11a of the cathode current collector within this range, the porosity of the cathode active material layer 12 may be reduced more effectively. The internal resistance of an all-solid secondary battery 100 including such cathode 10 may be reduced and the cycle characteristics may be improved.

A conductive coating layer may be absent (free) on the cathode current collector. The cathode current collector may not include a conductive coating layer disposed on the first surface and the second surface. The conductive coating layer may be a coating layer including, for example, a carbon-containing material.

The cathode current collector 11 may include, for example, a base film having a metal layer disposed on one or both surfaces of the base film. The base film may include, for example, a polymer. The polymer may be, for example, a thermoplastic polymer. The polymer may include, for example, polyethylene terephthalate (PET), polyethylene (PE), polypropylene (PP), polybutylene terephthalate (PBT), polyimide (PI), or a combination thereof. The base film may be, for example, an insulator. By including an insulating thermoplastic polymer, the base film may soften or melt in the event of a short circuit, thereby shutting down battery operation and suppressing a sudden increase in current. The metal layer may include, for example, indium (In), copper (Cu), magnesium (Mg), stainless steel, titanium (Ti), iron (Fe), cobalt (Co), nickel (Ni), zinc (Zn), aluminum (Al), germanium (Ge), or alloys thereof. The metal layer may function as an electrochemical fuse, breaking under overcurrent conditions to perform a short-circuit prevention function. The threshold current and maximum current may be controlled by adjusting the thickness of the metal layer. The metal layer may be plated or deposited on the base film. A thinner metal layer may reduce the threshold and/or maximum current of the cathode current collector 11, thus improving the safety of the lithium battery in the event of a short circuit. A lead tab may be added to the metal layer for external connection. The lead tab may be welded to the metal layer or the metal layer/base film laminate by ultrasonic welding, laser welding, spot welding, or the like. During welding, the base film and/or metal layer may melt, electrically connecting the metal layer to the lead tab. To enhance the robustness of the welding between the metal layer and the lead tab, a metal chip may be added between them. The metal chip may be a thin piece made of the same material as the metal layer. The metal chip may be, for example, metal foil, metal mesh, or the like. The metal chip may be, for example, aluminum foil, copper foil, SUS foil, or the like. By placing the metal chip on the metal layer and welding it to the lead tab, the lead tab may be welded to the metal chip/metal layer laminate or the metal chip/metal layer/base film laminate. During welding, the base film, metal layer, and/or metal chip may melt, electrically connecting the metal layer or metal layer/metal chip laminate to the lead tab. A metal chip and/or lead tab may be added to a portion of the metal layer. The thickness of the base film may be, for example, about 1 μm to about 50 μm, about 1.5 μm to about 50 μm, about 1.5 μm to about 40 μm, or about 1 μm to about 30 μm. By having the base film within such a thickness range, the weight of the electrode assembly 40, 40a, 40b may be reduced more effectively. The melting point of the base film may be, for example, from about 100° C. to about 300° C., from about 100° C. to about 250° C. or less, or from about 100° C. to about 200° C. By having a melting point within this range, the base film may melt during the lead tab welding process, allowing the base film to be easily bonded to the lead tab. Surface treatment, such as corona treatment, may be performed on the base film to improve adhesion between the base film and the metal layer. The thickness of the metal layer may be, for example, about 0.01 μm to about 3 μm, about 0.1 μm to about 3 μm, about 0.1 μm to about 2 μm, or about 0.1 to about 1 μm. By having a metal layer within this thickness range, the stability of the electrode assembly 40, 40a, 40b may be secured while maintaining conductivity. The thickness of the metal chip may be, for example, about 2 μm to about 10 μm, about 2 μm to about 7 μm, or about 4 μm to about 6 μm. By having the metal chip within this thickness range, the connection between the metal layer and the lead tab may be more easily achieved. By adopting such a structure for the cathode current collector 11, the weight of the cathode may be reduced, thereby improving the energy density of the cathode and, consequently, of the all-solid secondary battery 100.

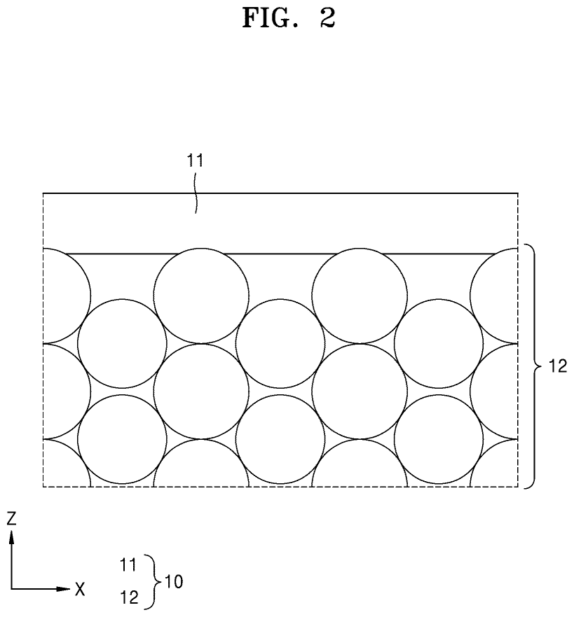

FIG. 2 is a cross-sectional schematic diagram of a cathode for an all-solid secondary battery according to the prior art. In FIG. 2, the spherical particles of the cathode active material layer 12 represent cathode active material particles, and solid electrolyte is placed between the cathode active material particles.

Referring to FIG. 2, the cathode 10 for an all-solid secondary battery includes a cathode current collector 11 and a solid electrolyte-containing cathode active material layer 12 on the cathode current collector 11. The cathode current collector 11 includes a first surface S11a adjacent to the cathode active material layer 12 and a second surface S11b opposing the first surface S11a. The highest surface roughness value R_{y2} of the second surface S11b of the cathode current collector is, for example, less than 1.5 μm. When preparing a cathode 10 for an all-solid secondary battery according to the prior art, the surface contour of the cathode active material layer 12 is not transferred to the second surface S11b of the cathode current collector when pressed by a hard roller, thereby reducing the highest surface roughness value R_{y2} of the second surface S11b. In addition, since the surface contour of the cathode active material layer 12 is not sufficiently transferred to the first surface S11a of the cathode current collector, the highest surface roughness value R_{y1} of the first surface S11a is also reduced. The highest surface roughness value R_{y1} of the first surface S11a of the cathode current collector is, for example, less than 1.0 μm. Since the cathode current collector 11 has such highest surface roughness value R_{y2} of the second surface S11b and such highest surface roughness value R_{y1} of the first surface S11a, it may be difficult for the porosity of the cathode active material layer 12 to be reduced. The internal resistance of an all-solid secondary battery 100 including such cathode 10 may be reduced and the cycle characteristics may be improved.

### Cathode Active Material Layer

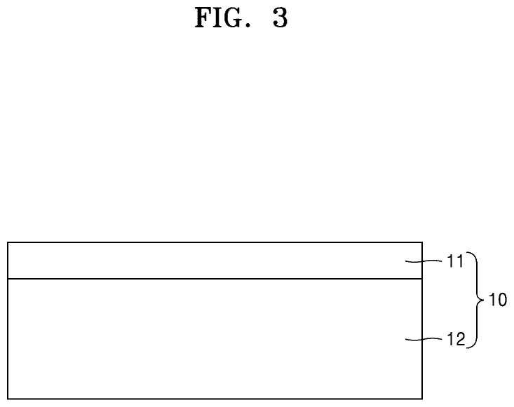

FIG. 3 is a cross-sectional schematic diagram of a cathode for an all-solid secondary battery according to an embodiment.

Referring to FIGS. 1 and 3, the cathode 10 for an all-solid secondary battery includes a cathode current collector 11 and a cathode active material layer 12.

The cathode active material layer 12 may have, for example, a reduced porosity.

The porosity refers to the ratio of the area occupied by pores to the entire area, excluding the area occupied by the cathode active material in the scanning electron microscope image of the cross-section of the cathode 10. The porosity may be measured, for example, from a scanning electron microscope image of a cross-section of the cathode active material layer 12. The cathode 10 may include a cathode current collector and a cathode active material, and the porosity of the cathode active material layer may be, for example, 14% or less, 10% or less, 8% or less, or 5% or less. By having the cathode active material layer within such a porosity range, the internal resistance of the cathode active material layer 12 may be further reduced and the ionic conductivity of the cathode active material layer 12 may be improved. The internal resistance of an all-solid secondary battery 100 including such cathode 10 may be reduced and the cycle characteristics may be improved.

### Cathode Active Material

The cathode active material layer 12 includes a cathode active material.

The cathode active material is a cathode active material capable of reversibly absorbing and desorbing lithium ions. The cathode active material may be, for example, a lithium transition metal oxide such as lithium cobalt oxide (LCO), lithium nickel oxide, lithium nickel cobalt oxide, lithium nickel cobalt aluminum oxide (NCA), lithium nickel cobalt manganese oxide (NCM), lithium manganate, lithium iron phosphate, or vanadium oxide, but is not necessarily limited thereto and any material used as a cathode active material in the relevant technical field may be used. The cathode active materials are either singular or a mixture of two or more types.

The lithium transition metal oxide may be, for example, a compound represented by one of the following Formulae: LiₐA_{1-b}B′_{b}D₂ (where 0.90≤a≤1, and 0≤b≤0.5); LiₐE_{1-b}B′_{b}O_{2-c}D_{c} (where 0.90≤a≤1, 0≤b≤0.5, and 0≤c≤0.05); LiE_{2-b}B′_{b}O_{4-c}D_{c} (where 0≤b≤0.5, and 0≤c≤0.05); LiₐNi_{1-b-c}Co_{b}B′_{c}D_{α} (where 0.90≤a≤1, 0≤b≤0.5, 0≤c≤0.05, and 0<α≤2); LiₐNi_{1-b-c}Co_{b}B′_{c}O_{2-α}F′_{α} (where 0.90≤a≤1, 0≤b≤0.5, 0≤c≤0.05, and 0<α<2); LiₐNi_{1-b-c}Mn_{b}B′_{c}D_{α} (where 0.90≤a≤1, 0≤5b≤0.5, 0≤c≤0.05, 0<α<2); LiₐNi_{1-b-c}Mn_{b}B′_{c}O_{2-α′}F′_{α} (where 0.90≤a≤1, 0≤b≤0.5, 0≤c≤0.05, and 0<α<2); and LiₐNi_{b}E_{c}G_{d}O₂ (where 0.90≤a≤1, 0≤b≤0.9, 0≤c≤0.5, and 0.001≤d≤0.1); LiₐNi_{b}Co_{c}Mn_{d}GeO₂ (where 0.90≤a≤1, 0≤b≤0.9, 0≤c≤0.5, 0≤d≤50.5, and 0.001≤e≤0.1.); LiₐNiG_{b}O₂ (where 0.90≤a≤1, and 0.001≤b≤0.1.); LiₐCoG_{b}O₂ (where 0.90≤a≤1, and 0.001≤b≤0.1.); LiₐMnG_{b}O₂ (where 0.90≤a≤1, and 0.001≤b≤0.1.); LiₐMn₂G_{b}O₄ (where 0.90≤a≤1, and 0.001≤b≤0.1.); QO₂; QS₂; LiQS₂; V₂O₅; LiV₂O₅; LiI′O₂; LiNiVO₄; Li_{(3-f)}J₂(PO₄)₃ (0≤f≤2); Li_{(3-f)}Fe₂(PO₄)₃ (0≤f≤2); or LiFePO₄. In these compounds, A is Ni, Co, Mn, or a combination thereof; B′ is Al, Ni, Co, Mn, Cr, Fe, Mg, Sr, V, a rare earth element, or a combination thereof; D is O, F, S, P, or a combination thereof; E is Co, Mn, or a combination thereof; F′ is F, S, P, or a combination thereof; G is Al, Cr, Mn, Fe, Mg, La, Ce, Sr, V, or a combination thereof; Q is Ti, Mo, Mn, or a combination thereof; I′ is Cr, V, Fe, Sc, Y, or a combination thereof; and J is V, Cr, Mn, Co, Ni, Cu, or a combination thereof. It is also possible to use compounds in which a coating layer is applied to the surface of the above-described compounds, as well as mixtures of the aforementioned compounds and those with coating layers. The coating layer added to the surface of such compounds may include, for example, a coating element compound such as an oxide of the coating element, a hydroxide of the coating element, an oxyhydroxide of the coating element, an oxycarbonate of the coating element, or a hydroxycarbonate of the coating element. The compounds forming these coating layers are amorphous or crystalline. The coating elements included in the coating layer may include Mg, Al, Co, K, Na, Ca, Si, Ti, V, Sn, Ge, Ga, B, As, Zr or a mixture thereof. The method of forming the coating layer may be selected within a range that does not adversely affect the properties of the cathode active material. Examples of coating methods include spray coating, and dipping. The specific coating methods are well understood by those skilled in the art, and therefore a detailed explanation is omitted.

The cathode active material may include, for example, a lithium transition metal oxide represented by Formulae 1 to 8:

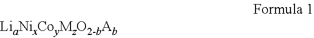

where in Formula 1,
1.0≤a≤1.2, 0≤b≤0.2, 0.8≤x≤1, 0≤y≤0.3, 0<z≤0.3, and x+y+z=1,
M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof,
A is F, S, Cl, Br or a combination thereof,

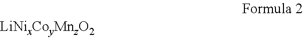

where in Formula 2,
0.8≤x≤0.95, 0≤y≤0.2, 0<z≤0.3, and x+y+z=1,

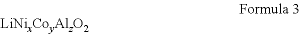

where in Formula 3,
0.8≤x≤0.95, 0≤y≤0.2, 0<z≤0.2 and x+y+z=1,

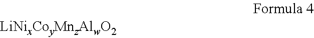

where in Formula 4,
0.8≤x≤0.95, 0≤y≤0.2, 0<z≤0.2, 0<w≤0.2, and x+y+z+w=1,

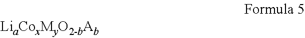

where in Formula 5,
1.0≤a≤1.2, 0≤b≤0.2, 0.9≤x≤1, 0≤y≤0.1, and x+y=1,
M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof,
A is F, S, Cl, Br or a combination of thereof,

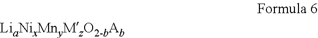

where in Formula 6,
1.0≤a≤1.2, 0≤b≤0.2, 0<x≤0.3, 0.5≤y<1, 0<z≤0.3, and x+y+z=1,
M′ is cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof,
A is F, S, Cl, Br or a combination thereof,

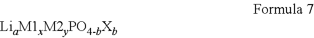

where in Formula 7, 0.90≤a≤1.1, 0≤x≤0.9, 0≤y≤0.5, 0.9<x+y<1.1, and 0≤b≤2,
M1 is chromium (Cr), manganese (Mn), iron (Fe), cobalt (Co), nickel (Ni), copper (Cu), zirconium (Zr), or a combination thereof,
M2 is magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y) or a combination thereof, and X is O, F, S, P or a combination thereof.

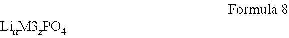

where in Formula 8, 0.90≤a≤1.1, 0.9≤z≤1.1, and
M3 is chromium (Cr), manganese (Mn), iron (Fe), cobalt (Co), nickel (Ni), copper (Cu), zirconium (Zr), or a combination thereof.

The oxide-containing cathode active material may be covered by a coating layer. The coating layer may be any layer known for use as a coating layer of a cathode active material of an all-solid secondary battery. The coating layer may be, for example, Li₂O—ZrO₂ (LZO).

The size of the oxide-containing cathode active material may be, for example, about 0.1 μm to about 30 μm, about 0.5 μm to about 20 μm or about 1 μm to about 15 μm. The oxide-containing cathode active material may be, for example, a single-crystalline particle or a polycrystalline particle.

The shape of the cathode active material may be, for example, a particle shape such as a sphere, an ellipse, or a sphere. The particle diameter of the cathode active material is not particularly limited and is within a range applicable to cathode active materials of conventional all-solid secondary batteries. The content of the cathode active material of the cathode 10 is not particularly limited, and is within a range applicable to the cathode 10 of a conventional all-solid secondary battery. The content of the cathode active material included in the cathode active material layer 12 may be about 80 wt % to about 99 wt %, about 80 wt % to about 95 wt %, or about 80 wt % to about 90 wt % of the total weight of the cathode active material layer 12.

### Solid Electrolyte

The cathode active material layer 12 may further include, for example, a solid electrolyte. The solid electrolyte may be, for example, a sulfide-containing solid electrolyte. The solid electrolyte included in the cathode 10 may be the same as or different from the solid electrolyte included in the solid electrolyte layer 30. For more information on the solid electrolyte, reference is made to the section on solid electrolyte layer 30.

The solid electrolyte included in the cathode active material layer 12 may have a smaller average D50 average particle diameter than the solid electrolyte included in the solid electrolyte layer 30. For example, the D50 average particle size of the solid electrolyte included in the cathode active material layer 12 may be 90% or less, 80% or less, 70% or less, 60% or less, 50% or less, 40% or less, 30% or less, or 20% or less of the D50 average particle size of the solid electrolyte included in the solid electrolyte layer 30. The D50 average particle size is, for example, the median particle diameter (D50). The median particle diameter (D50) is, for example, the particle size corresponding to 50% of the cumulative volume, calculated from the side of smaller particle sizes in the particle size distribution measured by a laser diffraction method. The solid electrolyte content included in the cathode active material layer 12 may be, for example, about 1 wt % to about 40 wt %, about 1 wt % to about 30 wt %, about 1 wt % to about 20 wt %, or about 1 wt % to about 10 wt % of the total weight of the cathode active material layer 12.

### Conductive Material

The cathode active material layer 12 may further include a conductive material. The conductive material may be, for example, a carbon-containing conductive material, a metal-containing conductive material, or a combination thereof. The carbon-containing conductive material may be, but is not limited to, graphite, carbon black, acetylene black, Ketjen black, carbon fiber, or a combination thereof, and any material used as a carbon-containing conductive material in the art may be used. The metal-containing conductive material may be, but is not limited to, metal powder, metal fiber, or a combination thereof, and any material used as a metal-containing conductive material in the relevant technical field may be used. The conductive material content included in the cathode active material layer 12 may be, for example, about 1 wt % to about 30 wt %, about 1 wt % to about 20 wt %, or about 1 wt % to about 10 wt % of the total weight of the cathode active material layer 12.

### Binder

The cathode active material layer 12 may further include a binder. The binder may be, but is not limited to, styrene butadiene rubber (SBR), polytetrafluoroethylene, polyvinylidene fluoride, polyethylene, or the like, and any binder used in the relevant technical field may be used. The binder content included in the cathode active material layer 12 may be, for example, about 1 wt % to about 10 wt % of the total weight of the cathode active material layer 12. The binder is optional.

### Other Additives

The cathode active material layer 12 may further include additives such as fillers, coating agents, dispersants, and ion conductive aids in addition to the cathode active material, solid electrolyte, binder, and conductive material described above.

As fillers, coating agents, dispersants, and ion conductivity aids that may be included in the cathode active material layer 12, known materials generally used in electrodes of all-solid secondary batteries may be used.

### All-Solid Secondary Battery

An all-solid secondary battery according to an embodiment includes the above-described cathode, an anode, and a solid electrolyte layer between the cathode and the anode.

By having a cathode with reduced porosity, the all-solid secondary battery may provide reduced internal resistance and improved cycle characteristics.

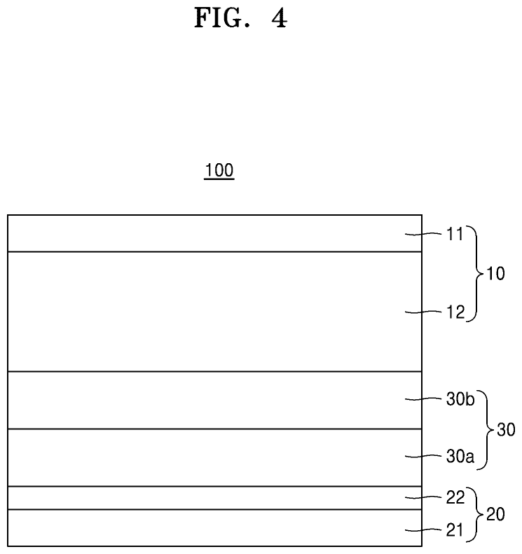

FIG. 4 is a cross-sectional schematic diagram of an all-solid secondary battery 100 according to an embodiment.

The all-solid secondary battery 100 includes a cathode 10, an anode 20, and a solid electrolyte layer 30. The cathode 10 includes a cathode current collector 11 and a cathode active material layer 12. The anode 20 includes an anode current collector 21 and an anode active material layer 22.

### Cathode

Reference is made to the aforementioned cathode.

### Anode

Referring to FIG. 4, the anode 20 includes an anode current collector 11 and an anode active material layer 22.

### Anode Active Material Layer

The ratio B/A of the initial charge capacity B of the anode active material layer 22 and the initial charge capacity A of the cathode active material layer 12 may be, for example, about 0.001 to about 0.45, about 0.005 to about 0.4, about 0.01 to about 0.3, about 0.01 to about 0.2, or about 0.01 to about 0.1. The initial charge capacity of the cathode active material layer 12 may be determined by charging from the 1^{st} open circuit voltage to the maximum charging voltage with respect to Li/Li⁺. The initial charge capacity of the anode active material layer 22 may be determined by charging from the 2^{nd} open circuit voltage to 0.01 V with respect to Li/Li⁺. The maximum charging voltage may be determined by the type of cathode material. The maximum charge voltage may be, for example, 1.5 V, 2.0 V, 2.5 V, 3.0 V, 3.5 V, 4.0 V, 4.2 V, or 4.3 V. For example, the maximum charge voltage of Li2S or Li2S complex may be determined between 2.5 and 3.0 V with respect to Li/Li⁺. For example, the maximum charge voltage of a lithium transition metal oxide may be determined between 3.0 and 4.5 V with respect to Li/Li⁺.

The initial charge capacity (milliampere-hour (mAh)) of the cathode active material layer 12 is obtained by multiplying the charge capacity density (charge specific capacity) (milliampere-hour per gram (mAh/g)) of the cathode active material by the mass (grams (g)) of the cathode active material in the cathode active material layer 12. When several types of cathode active materials are used, the charge capacity density x mass value is calculated for each cathode active material, and the sum of these values is the initial charge capacity of the cathode active material layer 12. The initial charge capacity of the anode active material layer 22 is also calculated in the same way. The initial charge capacity of the anode active material layer 22 is obtained by multiplying the charge capacity density (mAh/g) of the anode active material by the mass of the anode active material in the anode active material layer 22. When several types of anode active materials are used, the charge capacity density x mass value is calculated for each anode active material, and the sum of these values is the initial charge capacity of the anode active material layer 22. The charge capacity density of each of the cathode active material and the anode active material may be measured using an all-solid half-cell using lithium metal as a counter electrode. The initial charge capacity of each of the cathode active material layer 12 and the anode active material layer 22 may be directly measured using an all-solid half-cell at a constant current density, for example, 0.1 milliampere per square centimeter (mA/cm²). For the cathode, the measurements may be performed with respect to an operating voltage ranging from the 1^{st} open circuit voltage (OCV) to a maximum charge voltage, for example, up to 3.0 volts (V) (vs. Li/Li⁺). For the anode, the measurements may be performed with respect to an operating voltage ranging from the 2^{nd} open circuit voltage (OCV) to, for example, 0.01 V versus the anode, such as lithium metal. For example, an all-solid half-cell having a cathode active material layer may be charged from the 1^{st} open circuit voltage up to 3.0 V with a constant current of 0.1 mA/cm². An all-solid half-cell having a first anode active material layer may be charged from the 2^{nd} open circuit voltage down to 0.01 V with a constant current of 0.1 mA/cm². The current density during constant current charging may be, for example, 0.2 mA/cm² or 0.5 mA/cm². An all-solid half-cell having a cathode active material layer may be charged from the 1^{st} open circuit voltage to, for example, 2.5 V, 2.0 V, 3.5 V, 4.0 V or 4.5 V. The maximum charge voltage of the cathode active material layer may be determined based on the maximum voltage of a battery that satisfies the safety conditions defined in the Japanese Industrial Standard JISC8712:2015.

If the initial charge capacity of the anode active material layer 22 is too small, the thickness of the anode active material layer 22 becomes very thin, so that lithium dendrites formed between the anode active material layer 22 and the anode current collector 21 during repeated charge/discharge processes may cause the anode active material layer 22 to collapse, making it difficult to improve the cycle characteristics of the all-solid secondary battery 100. If the charge capacity of the anode active material layer 22 increases excessively, the energy density of the all-solid secondary battery 100 may decrease, and the internal resistance caused by the anode active material layer 22 may increase, making it difficult to improve the cycle characteristics of the all-solid-state secondary battery 100.

The thickness of the anode active material layer 22 may be, for example, 50% or less, 40% or less, 30% or less, 20% or less, or 10% or less of the thickness of the cathode active material layer 12. The thickness of the anode active material layer 22 may be, for example, about 1% to about 50%, about 1% to about 40%, about 1% to about 30%, about 1% to about 20%, or about 1% to about 10% of the thickness of the cathode active material layer 12. The thickness of the anode active material layer 22 is, for example, about 1 μm to about 50 μm, about 2 μm to about 40 μm, about 3 μm to about 30 μm, about 4 μm to about 20 μm or about 5 μm to about 20 μm. If the thickness of the anode active material layer 22 is too thin, lithium dendrites formed between the anode active material layer 22 and the anode current collector 21 may cause the anode active material layer 22 to collapse, making it difficult to improve the cycle characteristics of the all-solid secondary battery 100. If the thickness of the anode active material layer 22 increases excessively, the energy density of the all-solid secondary battery 100 decreases and the internal resistance of the all-solid secondary battery 100 due to the anode active material layer 22 increases, making it difficult to improve the cycle characteristics of the all-solid secondary battery 100. If the thickness of the anode active material layer 22 decreases, for example, the initial charge capacity of the anode active material layer 22 also decreases.

### Lithium Metal Layer

Although not shown in the drawing, the all-solid secondary battery 100 may further include a lithium metal layer, for example, disposed between the anode current collector 21 and the anode active material layer 22, after being charged. The lithium metal layer is a metal layer containing lithium or a lithium alloy. Therefore, the lithium metal layer is a metal layer containing lithium, and therefore acts as a lithium reservoir, for example. The lithium alloy may include, but is not limited to, a Li—Al alloy, a Li—Sn alloy, a Li—In alloy, a Li—Ag alloy, a Li—Au alloy, a Li—Zn alloy, a Li—Ge alloy, a Li—Si alloy, or the like, and any lithium alloy used in the relevant technical field may be used. The lithium metal layer may be composed of one of these alloys or lithium, or of a combination of several alloys. The lithium metal layer is, for example, a plated layer. The lithium metal layer may be deposited, for example, between the anode active material layer 22 and the anode current collector 21 during the charging process of an all-solid secondary battery 100.

The thickness of the lithium metal layer is not particularly limited, but is, for example, about 1 μm to about 200 μm, about 1 μm to about 150 μm, about 1 μm to about 100 μm, about 1 μm to about 50 μm, about 1 μm to about 30 μm, about 1 μm to about 22 μm or about 1 μm to about 10 μm. If the thickness of the lithium metal layer is too thin, it is difficult for the lithium metal layer to perform the role of a lithium reservoir. If the thickness of the lithium metal layer is too thick, the mass and volume of the all-solid secondary battery 100 may increase and the cycle characteristics of the all-solid secondary battery 100 may rather deteriorate.

The thickness of the lithium metal layer may be smaller than, for example, the thickness of the anode active material layer 22. The thickness of the lithium metal layer may be, for example, 70% or less, 60% or less, 50% or less, 40% or less, or 30% or less of the thickness of the anode active material layer 22. The thickness of the lithium metal layer may be, for example, about 1% to about 70%, about 1% to about 60%, about 1% to about 50%, about 1% to about 40%, or about 1% to about 30% of the thickness of the anode active material layer 22. By making the lithium metal layer thinner than the anode active material layer 22, volume changes during charge and discharge of the all-solid secondary battery may be suppressed. As a result, deterioration by volume change of the all-solid-state secondary battery may be suppressed.

Alternatively, in an all-solid secondary battery 100, the lithium metal layer may be placed between the anode current collector 21 and the anode active material layer 22, for example, before assembling the all-solid secondary battery 100. When the lithium metal layer is placed between the anode current collector 21 and the anode active material layer 22 before assembling the all-solid secondary battery 100, the lithium metal layer acts as a lithium reservoir because it is a metal layer containing lithium. For example, lithium foil may be placed between the anode current collector 21 and the anode active material layer 22 before assembling the all-solid secondary battery 100.

When a lithium metal layer is deposited by charging after assembling an all-solid secondary battery 100, the energy density of the all-solid secondary battery 100 increases because the lithium metal layer is not included during the assembling of the all-solid secondary battery 100. During charging of the all-solid secondary battery 100, charging is carried out beyond the capacity of the anode active material layer 22. That is, the anode active material layer 22 is overcharged. During the initial stage of charging, lithium is absorbed into the anode active material layer 22. The anode active material included in the anode active material layer 22 forms an alloy or compound with the lithium ions that have moved from the cathode 10. When charging exceeds the capacity of the anode active material layer 22, lithium begins to deposit, for example, on the rear side of the anode active material layer 22, i.e., between the anode active material layer 22 and the anode current collector 21, thereby forming a metal layer corresponding to the lithium metal layer. The lithium metal layer is a metal layer mainly composed of lithium (i.e., metallic lithium). These results are obtained, for example, by including a material that forms an alloy or compound with lithium in the anode active material layer 22. During discharge, lithium from the anode active material layer 22 and the lithium metal layer, i.e., the metal layer, is ionized and moves toward the cathode 10. Therefore, it is possible to use lithium as an anode active material in an all-solid secondary battery 100.

Furthermore, since the anode active material layer 22 covers the lithium metal layer, it not only acts as a protective layer for the lithium metal layer but also helps suppress the formation and growth of lithium dendrites. As a result, short-circuits and capacity degradation in the all-solid secondary battery 100 may be prevented, thereby improving its cycle performance. In addition, when a lithium metal layer is disposed by charging after assembling the all-solid secondary battery 100, the anode 20, i.e., the anode current collector 21 and the anode active material layer 22 and the region between them constitutes a Li-free regions that do not contain lithium Li in the initial state or the state after complete discharge of the all-solid secondary battery 100.

### Anode Active Material

The anode active material layer 22 includes an anode active material.

The anode active material may have a particle form, for example. The particle diameter of the anode active material is, for example, less than 1 μm, less than 500 nm, less than 300 nm, or less than 100 nm. The particle diameter of the anode active material is, for example, about 10 nm to less than about 1 μm, about 10 nm to about 900 nm, about 10 nm to about 700 nm, about 10 nm to about 500 nm, about 10 nm to about 300 nm, about 10 nm to about 200 nm or about 10 nm to about 100 nm. By having a particle diameter within this range, the anode active material may more easily perform the reversible absorption and/or desorption of lithium during charge and discharge. The particle diameter of the anode active material is, for example, the average particle diameter of the anode active material. The average particle diameter of the anode active material may be, for example, the median diameter (D50) measured using a laser particle size distribution meter. Alternatively, the particle diameter of the anode active material may be measured, for example, by scanning electron microscopy.

The aspect ratio of the anode active material is, for example, 5 or less, 4 or less, 3 or less, or 2 or less. The aspect ratio of the anode active material is, for example, about 1 to about 5, about 1 to about 4, about 1 to about 3, or about 1 to about 2. By having an aspect ratio within such a range, the anode active material may be more uniformly distributed within the anode active material layer 22. The unevenness of volume change during charge and discharge of the anode active material may be suppressed. The aspect ratio of the anode active material may be measured, for example, using a scanning electron microscope. By having an aspect ratio within this range, the anode active material may further improve the high-rate characteristics of an all-solid secondary battery including the anode active material.

The anode active material may include a metal-containing anode active material, a carbon-containing anode active material, or a combination thereof.

The metal-containing anode active material may include, for example, a metal capable of forming an alloy with lithium or a metal capable of forming a compound with lithium. The metal-containing cathode active material may include, for example, zinc (Zn), gold (Au), platinum (Pt), palladium (Pd), silicon (Si), silver (Ag), aluminum (Al), bismuth (Bi), tin (Sn), iridium (Ir), osmium (Os), rhodium (Rh), ruthenium (Ru), or a combination thereof. For example, nickel (Ni) does not form an alloy with lithium and therefore does not belong to the metal-containing anode active material as used herein.

The carbon-containing anode materials may include, for example, amorphous carbon, crystalline carbon, porous carbon, or a combination thereof. The carbon-containing anode materials may be, for example, amorphous carbon. Examples of amorphous carbon include carbon black (CB), acetylene black (AB), furnace black (FB), ketjen black (KB), graphene, or a combination thereof. Amorphous carbon is carbon that has no crystallinity or very low crystallinity, and is distinguished from crystalline carbon or graphitic carbon. The degree of crystallinity of a carbon-containing anode material may be calculated, for example, from the percentage of intensity of peaks attributable to crystalline carbon (I_{crystalline}) and the percentage of intensity of peaks attributable to amorphous carbon (Iₐₘₒᵣₚₕₒᵤₛ) in an x-ray diffraction (XRD) spectrum of the carbon-containing material. A lower percentage value indicates a carbon with low crystallinity. The carbon-containing anode material may be, for example, porous carbon. The pore volume contained in the porous carbon is, for example, from about 0.1 cubic centimeters per gram (cc/g) to about 10.0 cc/g, from about 0.5 cc/g to about 5 cc/g, or from about 0.1 cc/g to about 1 cc/g. The average pore diameter of the porous carbon may be, for example, about 1 nm to about 50 nm, about 1 nm to about 30 nm, or about 1 nm to about 10 nm. The BET surface area of porous carbon may be, for example, about 100 square meters per gram (m²/g) to about 3000 m²/g. The average pore size and BET surface area of porous carbon may be measured, for example, by a nitrogen gas adsorption method.

The anode active material layer 22 may include a second type of anode active material from the aforementioned anode active materials, or may include a mixture of a plurality of different anode active materials. The anode active material layer 22 may, for example, contain only amorphous carbon. Alternatively, the anode active material layer 22 may include zinc (Zn), gold (Au), platinum (Pt), palladium (Pd), silicon (Si), silver (Ag), aluminum (Al), bismuth (Bi), tin (Sn), iridium (Ir), osmium (Os), rhodium (Rh), ruthenium (Ru), or a combination thereof. Alternatively, the anode active material layer 22 may include a mixture of amorphous carbon and zinc (Zn), gold (Au), platinum (Pt), palladium (Pd), silicon (Si), silver (Ag), aluminum (Al), bismuth (Bi), tin (Sn), iridium (Ir), osmium (Os), rhodium (Rh), ruthenium (Ru), or a combination thereof. The mixing ratio of the mixture of a carbon-containing anode active material such as amorphous carbon and a metal-containing anode active material such as zinc may be in weight ratio, for example, about 99:1 to about 1:99, about 10:1 to about 1:2, about 5:1 to about 1:1, or about 4:1 to about 2:1. By having thee anode active material with such composition, the high-rate characteristics of the all-solid secondary battery 100 may be further improved.

The anode active material layer 22 includes an anode active material, and the anode active material may include, for example, a mixture of a first particles made of amorphous carbon and a second particles made of a metal-containing anode active material. Examples of the metal-containing anode active materials include gold (Au), platinum (Pt), palladium (Pd), silver (Ag), aluminum (Al), bismuth (Bi), tin (Sn), and zinc (Zn). The content of the second particles is about 1 wt % to about 60 wt %, about 8 wt % to about 60 wt %, about 10 wt % to about 50 wt %, about 15 wt % to about 40 wt %, or about 20 wt % to about 30 wt %, based on the total weight of the mixture of the first particles and the second particles. By having the second particles within such a content range, the cycle characteristics of the all-solid secondary battery 100 may be further improved.

### Binder

The anode active material layer 22 may further include a binder.

The binder may be, for example, a polymer binder. The polymer binder included in the anode active material layer 22 may be, for example, styrene-butadiene rubber (SBR), polytetrafluoroethylene, polyvinylidene fluoride, polyethylene, vinylidene fluoride/hexafluoropropylene copolymer, polyacrylonitrile, polymethyl methacrylate, or the like, but is not necessarily limited thereto and any binder used in the relevant technical field may be used. The binder may consist of a single or a plurality of different binders. The polymer binder may include, for example, a fluorinated binder.

By further including a binder in the anode active material layer 22, the anode active material layer 22 may be stabilized on the anode current collector 21. In addition, cracks in the anode active material layer 22 are suppressed despite changes in the volume and/or relative position of the anode active material layer 22 during the charge/discharge process. For example, when the anode active material layer 22 does not include a binder, it may easily detach from the anode current collector 21. As the anode active material layer 22 is detached from the anode current collector 21, the possibility of a short circuit occurring increases at the exposed portion of the anode current collector 21, as the anode current collector 21 comes into contact with the solid electrolyte layer 30. The anode active material layer 22 may be prepared by, for example, applying a slurry which contains a material constituting the anode active material layer 22 dispersed therein onto the anode current collector 21, followed by drying. By including a binder in the anode active material layer 22, stable dispersion of the anode active material and fibrous carbon-containing material in the slurry is possible. For example, when applying the slurry onto the anode collector 21 by screen printing, it is possible to suppress clogging of the screen (e.g., clogging by aggregates of the anode active material).

The binder content may be about 0.1 parts to about 20 parts by weight, about 0.1 parts to about 15 parts by weight, about 1 part to about 10 parts by weight, or about 5 parts to about 10 parts by weight based on 100 parts by weight of the anode active material. By having a binder content within this range, the high-rate characteristics of the all-solid secondary battery 100 may be further improved.

### Other Additives

The anode active material layer 22 may further include additives ordinarily used in the all-solid secondary battery 100, such as fillers, coating agents, dispersants, and ion conductivity aids.

### Anode Current Collector

The anode current collector 21 may be composed of, for example, a material that does not react with lithium, i.e., does not form an alloy or compound. The materials constituting the anode current collector 21 may include, but are not necessarily limited to, copper (Cu), stainless steel, titanium (Ti), iron (Fe), cobalt (Co), and nickel (Ni), and any material that can be used as an electrode current collector in the relevant technical field may be used. The anode current collector 21 may be composed of one of the above-described metals, or may be composed of an alloy or coating material of two or more metals. The anode current collector 21 is, for example, in the form of a plate or foil.

Although not shown in the drawing, the all-solid secondary battery 100 may further include a thin film containing an element capable of forming an alloy with lithium on one surface of the anode current collector 21. The thin film is placed between the anode current collector 21 and the anode active material layer 22. The thin film contains elements capable of forming an alloy with, for example, lithium. Elements capable of forming an alloy with lithium include, but are not necessarily limited to, gold, silver, zinc, tin, indium, silicon, aluminum, bismuth, or the like, and any element capable of forming an alloy with lithium in the relevant technical field may be used. The thin film may be composed of one of these metals or of an alloy of several types of metals. By disposing the thin film on one surface of the anode current collector 21, for example, the deposition form of the lithium metal layer 23 deposited between the thin film and the anode active material layer 22 becomes flatter, and the cycle characteristics of the all-solid secondary battery 100 may be further improved. The thickness of the thin film may be, for example, about 1 nm to about 800 nm, about 10 nm to about 700 nm, about 50 nm to about 600 nm, or about 100 nm to about 500 nm. If the thickness of the thin film is less than 1 nm, it may be difficult for the thin film to perform its function. If the thickness of the thin film is too thick, the thin film itself absorbs lithium, which reduces the amount of lithium deposit from the anode, lowering the energy density of the all-solid battery and deteriorating the cycle characteristics of the all-solid secondary battery 100. The thin film may be formed on the anode current collector 21 by, for example, a vacuum deposition method, a sputtering method, a plating method, or the like, but is not necessarily limited to these methods, and any method capable of forming a thin film in the relevant technical field is possible.

Although not shown in the drawing, the anode current collector 21 may include, for example, a base film and a metal layer disposed on one or both sides of the base film.

The base film may include, for example, a polymer. The polymer may be, for example, a thermoplastic polymer. The polymer may include, for example, polyethylene terephthalate (PET), polyethylene (PE), polypropylene (PP), polybutylene terephthalate (PBT), polyimide (PI), or a combination thereof. The polymer may be an insulating polymer. By including an insulating thermoplastic polymer in the base film, when a short circuit occurs, the base film softens or liquefies, thereby blocking battery operation and suppressing a rapid increase in current. The metal layer may include, for example, copper (Cu), stainless steel, titanium (Ti), iron (Fe), cobalt (Co), nickel (Ni), or alloys thereof. The anode current collector 21 may additionally include a metal chip and/or a lead tab. For more specific details on the base film, metal layer, metal chip, and lead tab of the anode current collector 21, reference is made to the aforementioned cathode current collector 11. By having such a structure, the anode current collector 21 may reduce the weight of the anode, thereby improving the energy density of the anode and lithium battery.

### Solid Electrolyte Layer

Referring to FIG. 4, the all-solid secondary battery 100 includes a solid electrolyte layer 30.

The solid electrolyte layer 30 may have, for example, a single-layer structure or a multi-layer structure. The solid electrolyte layer 30 may have a structure of, for example, about 2 layers to about 100 layers, about 2 layers to about 10 layers, or about 2 layers to about 4 layers.

The solid electrolyte layer 30 includes a first solid electrolyte layer 30a positioned adjacent to the cathode and a second solid electrolyte layer 30b positioned adjacent to the anode. The first solid electrolyte layer and the second solid electrolyte layer may be distinguished by one or more physical properties such as composition, density, and porosity. Alternatively, the first solid electrolyte layer 30a and the second solid electrolyte layer 30b are not distinguished in one or more physical properties such as composition, density, and porosity, but may be prepared separately and laminated during the preparing process of the all-solid secondary battery 100 to form a solid electrolyte layer.

The porosity P1 of the first solid electrolyte layer may be distinguished from the porosity P2 of the second solid electrolyte layer, for example. The porosity P1 of the first solid electrolyte layer may be lower than the porosity P2 of the second solid electrolyte layer, for example. The ratio P1/P2 of the porosity P1 of the first solid electrolyte layer and the porosity P2 of the second solid electrolyte layer may be less than 1, 0.99 or less, 0.95 or less, or 0.9 or less. For example, the first solid electrolyte layer may be prepared by being pressurized at a higher pressure than the second solid electrolyte layer.

Alternatively, the porosity P1 of the first solid electrolyte layer may be higher than the porosity P2 of the second solid electrolyte layer, for example. The ratio P1/P2 of the porosity P1 of the first solid electrolyte layer and the porosity P2 of the second solid electrolyte layer may be greater than 1, 1.01 or more, 1.05 or more, or 1.1 or more. For example, the first solid electrolyte layer may be prepared by being pressurized at a lower pressure than the second solid electrolyte layer.

The porosity P1 of the first solid electrolyte layer and the porosity P2 of the second solid electrolyte layer are the ratios of the area of pores to the total area of the solid electrolyte layer, respectively, measured from scanning electron microscope images of the cross-section of the secondary battery.

### Solid Electrolyte

The solid electrolyte layer 30 contains a solid electrolyte.

The solid electrolyte may include, for example, a sulfide-containing solid electrolyte, an oxide-containing solid electrolyte, a polymer solid electrolyte, or a combination thereof.

The solid electrolyte may be, for example, a sulfide-containing solid electrolyte. The sulfide-containing solid electrolyte may be at least one of Li₂S—P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m, n are positive numbers, and Z is one of Ge, Zn, or Ga), Li₂S—GeS₂, Li₂S—SiS₂—Li₃PO₄, Li₂S—SiS₂-LiₚMO_{q}, (where p, q are positive numbers, and M is one of P, Si, Ge, B, Al, Ga, In), Li₇₋ₓPS₆₋ₓClₓ (0≤x≤2), Li₇₋ₓPS₆₋ₓBrₓ (0≤x≤2), or Li₇₋ₓPS₆₋ₓIₓ (0≤x≤2). The sulfide-containing solid electrolytes are prepared by processing starting materials such as Li₂S and P₂S₅ using a melt-quenching method or mechanical milling method. Additionally, heat treatment may be performed after this treatment. The solid electrolytes may be amorphous, crystalline, or a mixture of these. In addition, the solid electrolyte may include, for example, at least sulfur (S), phosphorus (P), and lithium (Li) as constituent elements among the sulfide-containing solid electrolyte materials described above. For example, the solid electrolyte may be a material containing Li₂S—P₂S₅. When using a sulfide-containing solid electrolyte material including Li₂S—P₂S₅ to form a solid electrolyte, the mixing molar ratio of Li₂S and P₂S₅ is, for example, in the range of Li₂S:P₂S₅=about 20:80 to about 90:10, about 25:75 to about 90:10, about 30:70 to about 70:30, and about 40:60 to about 60:40.

The sulfide-containing solid electrolyte may include, for example, an argyrodite type solid electrolyte represented by Formula A:

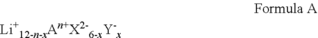

where in Formula A, A is P, As, Ge, Ga, Sb, Si, Sn, Al, In, Ti, V, Nb, or Ta, X is S, Se, or Te, Y is Cl, Br, I, F, CN, OCN, SCN, or N₃, and 1≤n≤5, 0≤x≤2. The sulfide-containing solid electrolyte may be, for example, an argyrodite-type compound including at least one of Li₇₋ₓPS₆₋ₓClₓ (where 0≤x≤2), Li₇₋ₓPS₆₋ₓBrₓ (where 0≤x≤2), or Li₇₋ₓPS₆₋ₓIₓ (where 0≤x≤2). The sulfide-containing solid electrolyte may be, for example, an argyrodite-type compound including at least one of Li₆PS₅Cl, Li₆PS₅Br, or Li₆PS₅I.

The density of the argyrodite-type solid electrolyte may be about 1.5 grams per cubic centimeter (g/cc) to about 2.0 g/cc. Since the argyrodite-type solid electrolyte has a density of 1.5 g/cc or more, the internal resistance of the all-solid secondary battery may be reduced, and penetration of the solid electrolyte layer by Li may be effectively suppressed.

The oxide-containing solid electrolytes may include, for example, Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y} Ti_{y}O₃(PLZT)(0≤x<1, 0≤y<1), PB(Mg₃Nb_{2/3})O₃—PbTiO₃(PMN-PT), HfG₂, SrTiO₃, SnG₂, CeG₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0≤x≤2, 0≤y≤3), LiₓAl_{y}Ti_{z}(PO₄)₃ (0<x<2, 0<y<1, 0<z<3), Li_{1+x+y} (Al, Ga)ₓ(Ti, Ge)₂₋ₓSi_{y}P_{3-y}O₁₂ (0≤x≤1 0≤y≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M=Te, Nb, or Zr, and 0≤x≤10), or a combination thereof. The oxide-containing solid electrolytes are prepared, for example, by sintering methods.

The oxide-containing solid electrolytes may include garnet-type solid electrolytes such as Li₇La₃Zr₂O₁₂(LLZO) and M doped LLZO represented by Li₃₊ₓLa₃Zr₂₋ₐMₐO₁₂ (where M=Ga, W, Nb, Ta, or Al, 0<a<2, and 0≤x≤10).

The polymer solid electrolyte may, for example, include a mixture of a lithium salt and a polymer, or may include a polymer having ion-conductive functional groups. The polymer solid electrolyte may be, for example, a polymer electrolyte that is solid at 25° C. and 1 atmosphere (atm). The polymer solid electrolytes may, for example, not contain liquid. The polymer solid electrolyte includes a polymer, which may be, for example, polyethylene oxide (PEO), polyvinylidene fluoride (PVDF), vinylidene fluoride-hexafluoropropylene (PVDF-HFP), polyethylene oxide (PEO), poly(styrene-b-ethylene oxide) block copolymer (PS-PEO), poly(styrene-butadiene), poly(styrene-isoprene-styrene), poly(styrene-b-divinylbenzene) block copolymer, poly(styrene-ethylene oxide-styrene) block copolymer, polystyrene sulfonate (PSS), polyvinyl fluoride (PVF), polymethyl methacrylate (PMMA, poly(methyl methacrylate)), polyethylene glycol (PEG), polyacrylonitrile (PAN), polytetrafluoroethylene (PTFE), polyethylene dioxythiophene (PEDOT), polypyrrole (PPY), polyacrylonitrile (PAN), polyaniline, polyacetylene, sulfonated and other ionic polymers and copolymers, e.g., those available under the trade names Nafion, Aquivion, Flemion, Gore, Aciplex, and Morgane ADP, sulfonated poly(ether ether ketone) (SPEEK), sulfonated poly(arylene ether ketone ketone sulfone) (SPAEKKS), sulfonated poly(aryl ether ketone (SPAEK), poly[bis(benzimidazobenzisoquinolinones)](SPBIBI), poly(styrene sulfonate) (PSS), lithium 9,10-diphenylanthracene-2-sulfonate (DPASLi⁺) or a combination thereof, but is not limited thereto, and any polymer electrolyte used in the art may be used. Lithium salts may include any material that may be used as a lithium salt in the relevant technical field. Examples of lithium salts include LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where x and y are 1 to 20, respectively), LiCl, LiI, or mixtures thereof. The polymer included in the polymer solid electrolyte may be, for example, a compound containing 10 or more, 20 or more, 50 or more, or 100 or more repeating units. The weight average molecular weight of the polymer included in the polymer solid electrolyte may be, for example, 1000 Dalton or more, 10,000 Dalton or more, 100,000 Dalton or more, or 1,000,000 Dalton or more.

A gel electrolyte may be, for example, a polymer gel electrolyte. A gel electrolyte may have a gel state without containing a polymer, for example.

The polymer gel electrolyte may include, for example, a liquid electrolyte and a polymer, or an organic solvent and a polymer having an ion-conductive functional group. The polymer gel electrolyte may be, for example, a polymer electrolyte that is in a gel state at 25° C. and 1 atm. The polymer gel electrolytes may also be in a gel state without containing liquid. The liquid electrolyte used in the polymer gel electrolyte may be, for example, an ionic liquid, a mixture of a lithium salt and an organic solvent; a mixture of a lithium salt and an organic solvent; a mixture of an ionic liquid and an organic solvent; or a mixture of a lithium salt, an ionic liquid, and an organic solvent. The polymer used in the polymer gel electrolyte may at least one of the polymers used in the solid polymer electrolyte. The organic solvent may be at least one of the organic solvents used in liquid electrolytes. Examples of organic solvents include propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethyl sulfoxide, dioxane, 1,2-dimethoxyethane, sulfolane, dichloroethane, chlorobenzene, nitrobenzene, diethylene glycol, dimethyl ether or mixtures thereof. The lithium salt may be at least one of the lithium salts used in polymer solid electrolytes. The ionic liquid refers to a salt that has a melting point at or below room temperature, is composed entirely of ions, and existing in a liquid state at room temperature, or also referred to as a room-temperature molten salt. The ionic liquid may include at least one of a compound including, for example, a) at least one cation such as ammonium, pyrrolidinium, pyridinium, pyrimidinium, imidazolium, piperidinium, pyrazolium, oxazolium, pyridazinium, phosphonium, sulfonium, triazolium, or mixtures thereof, and b) at least one anion such as BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, or (CF₃SO₂)₂N⁻. The polymer solid electrolyte may form a polymer gel electrolyte, for example, by being impregnated into a liquid electrolyte in a secondary battery. The polymer gel electrolyte may further contain inorganic particles. The polymer included in the polymer gel electrolyte may be, for example, a compound containing 10 or more, 20 or more, 50 or more, or 100 or more repeating units. The weight average molecular weight of the polymer included in the polymer gel electrolyte may be, for example, 500 Dalton or more, 1000 Dalton or more, 10,000 Dalton or more, 100,000 Dalton or more, or 1,000,000 Dalton or more.

### Binder

The solid electrolyte layer 30 may further include a binder. The binder included in the solid electrolyte layer 30 may be, for example, styrene butadiene rubber (SBR), polytetrafluoroethylene, polyvinylidene fluoride, polyethylene, or the like, but is not limited thereto, and any binder used in the relevant technical field may be used. The binder of the solid electrolyte layer 30 may be at least one of the binders used in the cathode active material layer 12 and the anode active material layer 22. The binder is optional. The binder content of the solid electrolyte layer 30 is, for example, about 0.1 wt % to about 10 wt % with respect to the total weight of the solid electrolyte layer 30.

### Preparation Method of An All-Solid Secondary Battery

A method of preparing an all-solid secondary battery according to another embodiment includes applying a first pressurization to a cathode and a solid electrolyte layer together with a first pressurization auxiliary layer to prepare a cathode-solid electrolyte layer laminate; and applying a second pressurization to the cathode-solid electrolyte layer laminate and an anode-solid electrolyte layer laminate together with a second pressurization auxiliary layer to prepare the all-solid secondary battery. A cathode including a cathode active material layer having reduced porosity and improved ionic conductivity may be prepared by pressurizing the cathode together with a first pressurization auxiliary layer. An all-solid secondary battery providing reduced porosity, reduced internal resistance, and improved cycle characteristics may be prepared by pressurizing a cathode, a solid electrolyte layer, and an anode together with a second pressurization auxiliary layer.

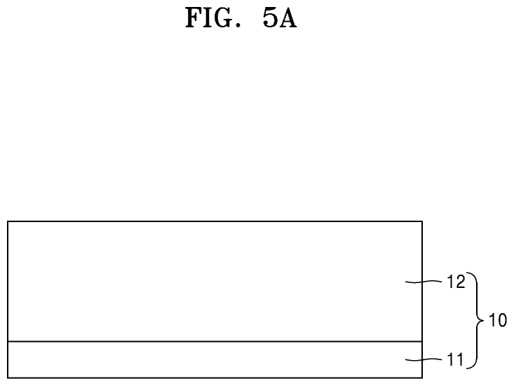

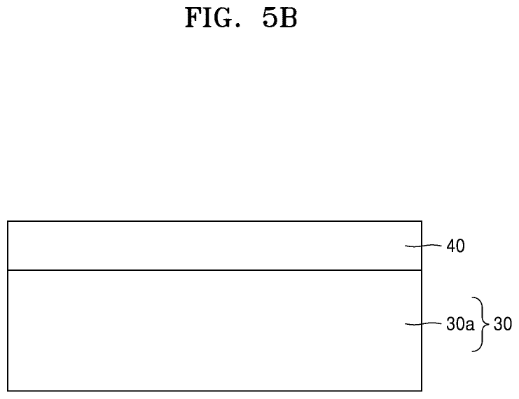

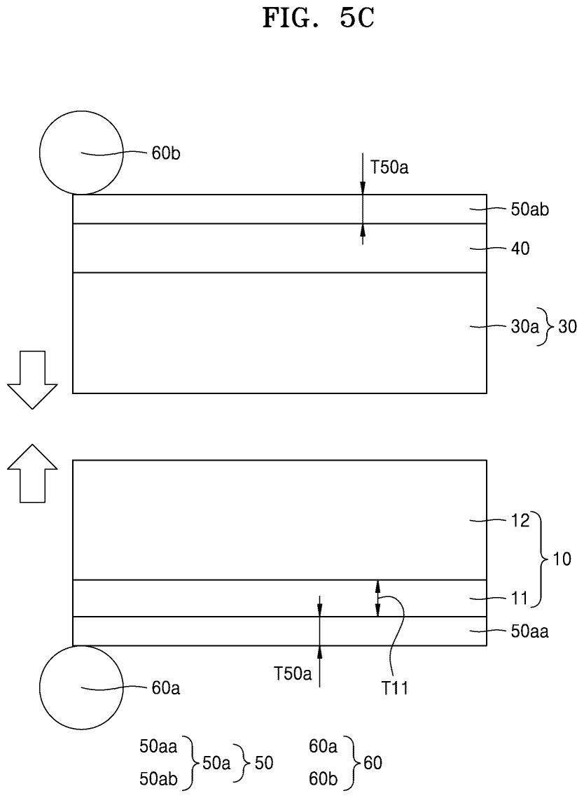

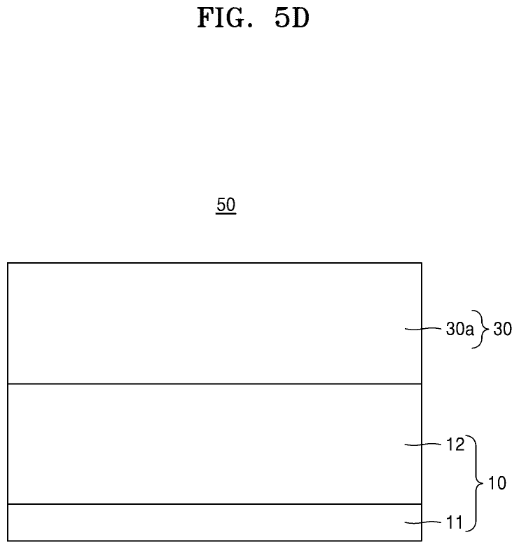

FIG. 5A is a cross-sectional schematic diagram of a cathode used in a method for preparing an all-solid secondary battery according to an embodiment. FIG. 5B is a cross-sectional schematic diagram of a solid electrolyte layer/protective layer laminate used in a method for preparing an all-solid secondary battery according to an embodiment. FIG. 5C is a cross-sectional schematic diagram of a first pressurization process used in a method for preparing an all-solid secondary battery according to an embodiment. FIG. 5D is a cross-sectional schematic diagram of a cathode-solid electrolyte laminate used in a method of preparing an all-solid secondary battery according to an embodiment.

First, the cathode 10 and the solid electrolyte layer are subjected to a first pressurization together with the first pressurization auxiliary layer to prepare an anode-solid electrolyte layer laminate.

Referring to FIG. 5A, a cathode 10 is prepared. A cathode active material slurry is prepared by mixing a cathode active material, a solid electrolyte, a binder, a conductive material, and a solvent. A cathode is prepared by coating and drying a cathode active material slurry on one surface of a cathode current collector 11. Alternatively, the cathode active material composition may be cast on a separate support, and then the film obtained by peeling off the support may be laminated onto a cathode current collector 11 to prepare a cathode 10.

Referring to FIG. 5B, a solid electrolyte layer 30, 30a/protective layer 40 laminate is prepared. A solid electrolyte slurry is prepared by mixing a solid electrolyte, a binder, and a solvent. A solid electrolyte slurry is coated and dried on one surface of the substrate to prepare a solid electrolyte layer 30, 30b. Alternatively, the solid electrolyte composition may be cast on a separate support and then peeled off from the support to prepare a film-shaped solid electrolyte layer 30, 30a. For pressurization, a solid electrolyte layer 30, 30a is placed on a protective layer 40 to prepare a solid electrolyte layer 30, 30a/protective layer 40 laminate. The protective layer 40 may be, for example, a metal sheet having a thickness of 1 mm or more. The metal sheet may be, for example, an aluminum sheets or a stainless steel sheet. The protective layer 40 may prevent cracks, or the like in the solid electrolyte layer 30, 30a when pressurized.

Referring to FIG. 5C, the cathode 10 and the solid electrolyte layer 30, 30a/protective layer 40 laminate are pressurized using the first pressurization auxiliary layer 50, 50a. A solid electrolyte layer 30, 30a/protective layer 40 laminate is placed on the cathode active material layer 12 of the cathode 10, and first pressurization auxiliary layers 50a, 50aa, 50ab are placed on both surfaces thereof. The cathode 10 includes a cathode current collector 11 and a cathode active material layer 12 on one surface of the cathode current collector 11, and a first pressurization auxiliary layer 50a, 50aa is arranged on the other surface of the cathode current collector 11. The solid electrolyte layer 30, 30a/protective layer 40 laminate includes a protective layer 40 and a solid electrolyte layer 30, 30a on one surface of the protective layer 40, and a first pressurization auxiliary layer 50a, 50ab is disposed on the other surface of the protective layer 40. By the first pressurization, a first pressurization auxiliary layer 50aa/cathode current collector 11/cathode active material layer 12/solid electrolyte layer 30a/protective layer 40/first pressurization auxiliary layer 50ab laminate is prepared. The first pressurization may be performed, for example, by rollers 60, 60a, 60b.

Referring to FIG. 5D, after the first pressurization, the protective layer 40 and the first pressurization auxiliary layer 50aa, 50ab are removed, and a cathode-solid electrolyte laminate having a cathode current collector 11/cathode active material layer 12/solid electrolyte layer 30a structure is prepared.

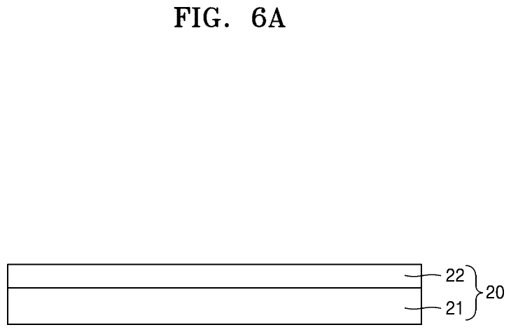

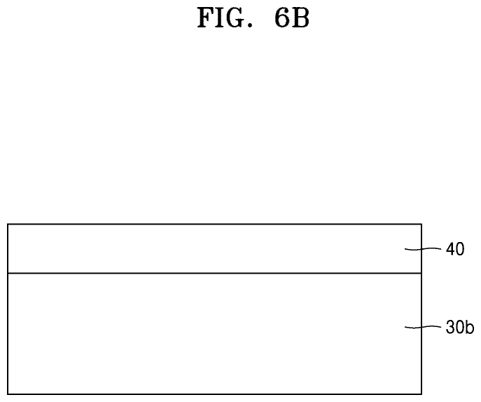

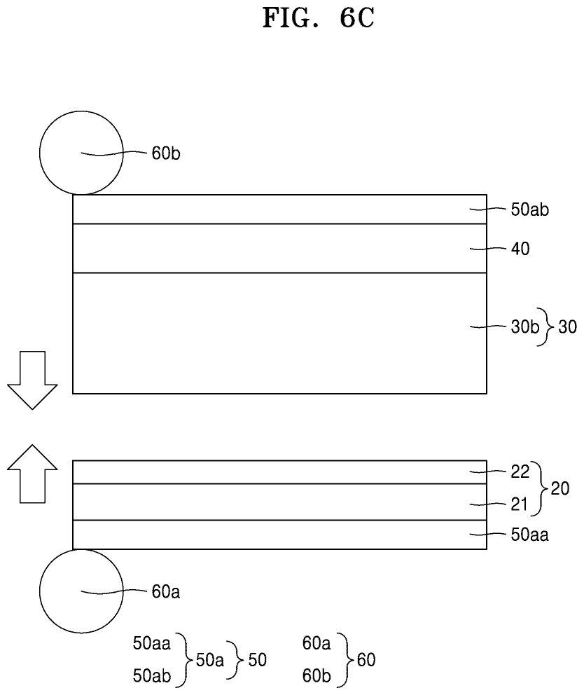

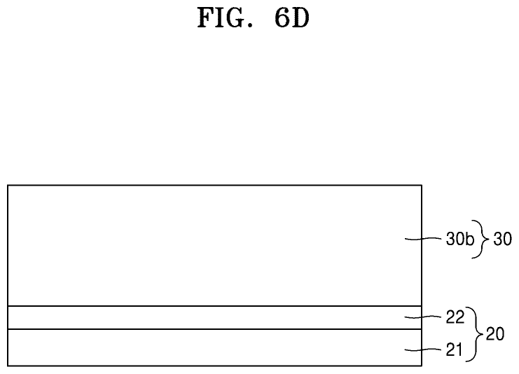

FIG. 6A is a cross-sectional schematic diagram of an anode used in a method of preparing an all-solid secondary battery according to an embodiment. FIG. 6B is a cross-sectional schematic diagram of a solid electrolyte layer/protective layer laminate used in a method of preparing an all-solid secondary battery according to an embodiment. FIG. 6C is a cross-sectional schematic diagram of a first pressurization process used in a method of preparing an all-solid secondary battery according to an embodiment. FIG. 6D is a cross-sectional schematic diagram of an anode-solid electrolyte laminate used in a method of preparing an all-solid secondary battery according to an embodiment.

Next, an anode 20 and the solid electrolyte layer 30, 30b are subjected to a first pressurization together with the first pressurization auxiliary layer 50a, 50aa, 50ab to prepare an anode-solid electrolyte laminate.

Referring to FIG. 6A, an anode 20 is prepared. An anode active material slurry is prepared by mixing an anode active material, a binder, and a solvent. The anode 20 is prepared by coating and drying an anode active material slurry on one surface of an anode current collector 21. Alternatively, the anode active material composition may be cast on a separate support, and then the film obtained by peeling off the support may be laminated onto an anode current collector 21 to prepare an anode 20.

Referring to FIG. 6B, a solid electrolyte layer 30, 30b/protective layer 40 laminate is prepared. The solid electrolyte layer 30, 30b/protective layer 40 laminate is prepared in the same manner as in the cathode-solid electrolyte laminate. Referring to FIG. 6C, the anode 20 and the solid electrolyte layer 30, 30b/protective layer 40 laminate are pressurized using the first pressurization auxiliary layer 50a, 50aa, 50ab. A solid electrolyte layer 30, 30b/protective layer 40 laminate is placed on the anode active material layer 22 of the anode 20, and first pressurization auxiliary layers 50a, 50aa, 50ab are placed on both surfaces thereof. The anode 20 includes an anode current collector 21 and an anode active material layer 22 on one surface of the anode current collector 21, and a first pressurization auxiliary layer 50a, 50aa is disposed on the other surface of the anode current collector 21. The solid electrolyte layer 30, 30b/protective layer 40 laminate includes a protective layer 40 and a solid electrolyte layer 30, 30b on one surface of the protective layer 40, and a first pressurization auxiliary layer 50a, 50ab is disposed on the other surface of the protective layer 40. By the first pressurization, a first pressurization auxiliary layer 50aa/anode current collector 21/anode active material layer 22/solid electrolyte layer 30b/protective layer 40/first pressurization auxiliary layer 50ab laminate is prepared. The first pressurization may be performed, for example, by rollers 60, 60a, 60b.

Referring to FIG. 6D, after the first pressurization, the protective layer 40 and the first pressurization auxiliary layer 50aa, 50ab are removed, and an anode-solid electrolyte laminate having a structure of a anode current collector 21/anode active material layer 22/solid electrolyte layer 30b is prepared.

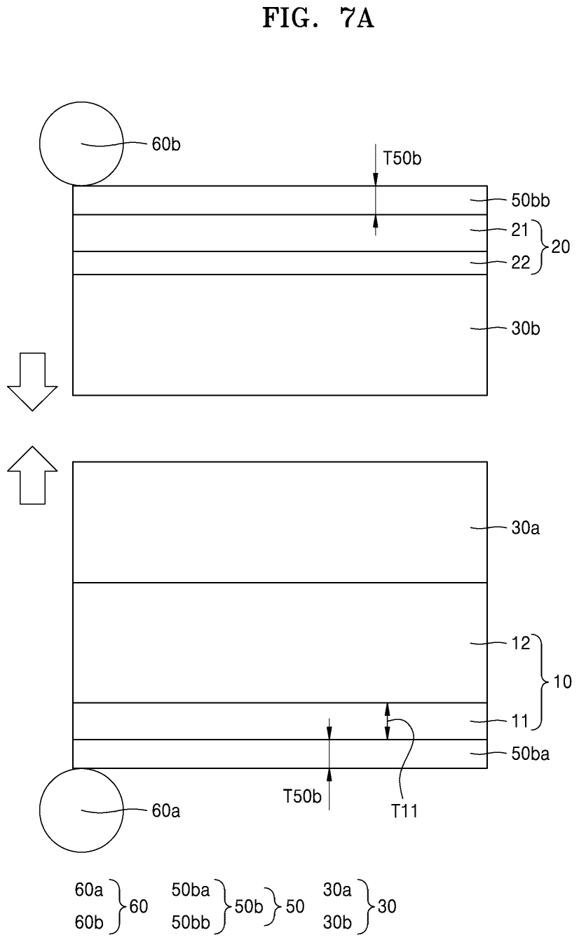

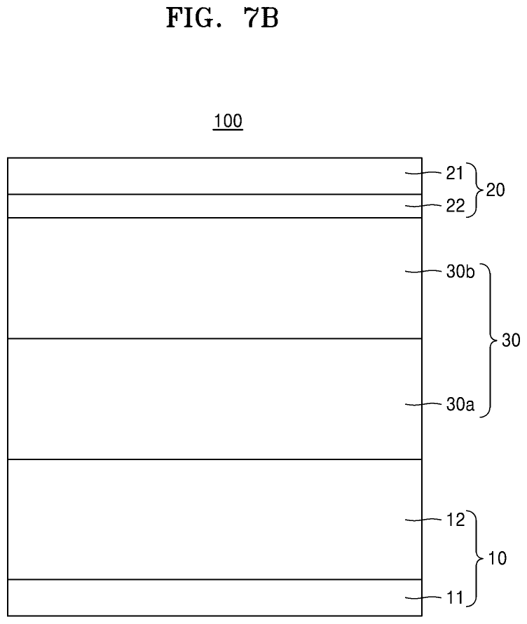

FIG. 7A is a cross-sectional schematic diagram of a second pressurization process used in a method of preparing an all-solid secondary battery according to an embodiment. FIG. 7B is a cross-sectional schematic diagram of an all-solid secondary battery prepared by a preparing method according to an embodiment.

Next, the cathode-solid electrolyte layer laminate and the anode-solid electrolyte layer laminate are subjected to a second pressurization together with a second pressurization auxiliary layer 50b, 50ba, 50bb to prepare an all-solid secondary battery 100.

Referring to FIG. 7A, the cathode-solid electrolyte layer laminate and the anode-solid electrolyte layer laminate are pressurized using the second pressurization auxiliary layer 50ba, 50bb. A cathode-solid electrolyte layer laminate is placed on the solid electrolyte layer 30a of the cathode-solid electrolyte layer laminate, and the second pressurization auxiliary layers 50b, 50ba, 50bb are placed on both surfaces thereof. The cathode-solid electrolyte layer laminate includes a cathode current collector 11, a cathode active material layer 12 on one surface of the cathode current collector 11, and a solid electrolyte layer 30, 30a on the cathode active material layer 12, and a second pressurization auxiliary layer 50ba is disposed on the other surface of the cathode current collector 11. The anode-solid electrolyte layer laminate includes an anode current collector 21, an anode active material layer 22 on one surface of the anode current collector 21, and a solid electrolyte layer 30, 30b on the anode active material layer 22, and a second pressurization auxiliary layer 50bb is disposed on the other surface of the anode current collector 21. By the second pressurization, a second pressurization auxiliary layer 50ba/cathode current collector 11/cathode active material layer 12/solid electrolyte layer 30a/solid electrolyte layer 30b/anode active material layer 22/anode current collector 21/second pressurization auxiliary layer 50bb laminate is prepared. The second pressurization may be performed, for example, by rollers 60, 60a, 60b.

Referring to FIG. 7B, after the second pressurization, the second pressurization auxiliary layer 50ba, 50bb is removed, thereby preparing an all-solid secondary battery 100 having a structure of cathode current collector 11/cathode active material layer 12/solid electrolyte layer 30a/solid electrolyte layer 30b/anode active material layer 22/anode current collector 21.

The first pressurization auxiliary layer 50a and the second pressurization auxiliary layer 50b may include, for example, a polymer, metal, wood, or a combination thereof.

The polymer may include, for example, polyimide (PI), polyethylene terephthalate (PET), polytetrafluoroethylene (PTFE), polystyrene (PS), polycarbonate (PC), polyvinyl chloride (PVC), polyvinyl alcohol, polyacrylate, polyethylene, polypropylene, polystyrene, polyisobutylene, polyvinyl chloride, polyvinyl acetate resin, polytetrafluoroethylene, polyacrylonitrile, poly(methyl acrylate), a polyester or polyester-cotton blend (e.g., Tetoron, nylon, a phenolic resin (e.g., Bakelite), urea resin, polysiloxane, or a combination thereof. The metal may include, for example, a metal belonging to groups 2 to 16 of the periodic table. The metal may include, for example, aluminum, copper, SUS, zinc, tin, lead, magnesium, titanium, nickel or a combination thereof. The pressurization auxiliary layer may be, for example, a polymer film. The pressurization auxiliary layer may be a multilayer film including, for example, a polymer layer and a metal layer. The pressurization auxiliary layer may have, for example, a polymer layer structure, a polymer layer/metal layer structure, a polymer layer/metal layer/polymer layer structure, or the like.

The thickness of the first pressurization auxiliary layer T50a and/or the thickness of the second pressurization auxiliary layer T50b may be, for example, greater than the thickness of the cathode current collector T11. The ratio T50a/T11 and/or T50b/T11 of the thickness of the first pressurization auxiliary layer T50a and/or the thickness of the second pressurization auxiliary layer T50b to the thickness of the cathode current collector T11 may be, for example, greater than 1, 0.1 or more, 0.5 or more, or 2 or more. The ratio(s) of the thickness of the first pressurization auxiliary layer T50a and/or the second pressurization auxiliary layer T50b to the thickness of the cathode current collector T11, i.e., T50a/T11 and/or T50b/T11, may each be, for example, greater than about 1 to about 100, about 0.1 to about 50, about 0.5 to about 20, or about 2 to about 10. When the first pressurization auxiliary layer thickness T50a and/or the second pressurization auxiliary layer thickness T50b is greater than the cathode current collector thickness T11, the porosity of the cathode active material layer may be reduced and the internal resistance of the cathode active material layer may be reduced.

The first pressurization auxiliary layer thickness T50a and/or the second pressurization auxiliary layer thickness T50b may be, for example, 1 mm or less, 900 μm or less, 500 μm or less, or 300 μm or less. The first pressurization auxiliary layer thickness T50a and/or the second pressurization auxiliary layer thickness T50b may be, for example, about 20 μm to about 1 mm, about 20 μm to about 900 μm, about 20 μm to about 500 μm, about 20 μm to about 300 μm, or about 20 μm to about 100 μm. By having the first and second pressurization auxiliary layers within such thicknesses range, a more uniform pressure may be transmitted to the anode layer. By transmitting uniform pressure to the cathode layer, the internal resistance of the cathode layer may be further reduced and the porosity of the cathode layer may be further reduced. The cycle characteristics of all-solid secondary batteries may be improved.

The first pressurization and the second pressurization may be performed by a roll press, a plate press, a warm isostatic press (WIP), a cold isostatic press (CIP), or a hot isostatic press (HIP), respectively. For ease of mass production, a roll press or plate press may be used. To obtain lower porosity, a warm isostatic press (WIP), a cold isostatic press (CIP) or a hot isostatic press (HIP) can be used.

The pressure of the first pressurization PR1 may be greater than the pressure of the second pressurization PR2. The ratio PR1/PR2 of the pressure of the first pressurization PR1 and the pressure of the second pressurization PR2 may be 2 or more, 5 or more, 10 or more, or 20 or more. The ratio PR1/PR2 of the pressure of the first pressurization PR1 to the pressure of the second pressurization PR2 may be about 2 to about 100, about 5 to about 100, about 10 to about 100, or about 20 to about 100. By having the ratio PR1/PR2 of the pressure of the first pressurization PR1 to the pressure of the second pressurization PR2 within this range, a uniform pressure is transmitted to the cathode layer, thereby further reducing the internal resistance of the cathode layer and further reducing the porosity of the cathode layer. The cycle characteristics of all-solid secondary batteries may be improved.

The disclosure is explained in more detail through the following examples and comparative examples. However, the examples are intended to illustrate the disclosure and the scope of the disclosure is not limited to these examples.

### Preparation of All-solid Secondary Battery

### Example 1

### Preparation of Pre-Cathode-Solid Electrolyte Laminate

LiNi_{0.8}Co_{0.15}Mn_{0.05}O₂ (NCM) coated with Li₂O—ZrO₂ (LZO) was prepared as a cathode active material. The LZO-coated cathode active material was prepared according to the method disclosed in Korean Laid-Open Publication No. 10-2016-0064942. Li₆PS₅Cl, an argyrodite-type crystal, was prepared as a solid electrolyte (average particle size (D50)=0.5 μm, crystalline). Polytetrafluoroethylene (PTFE) binder was used as a binder. Carbon nanotubes (CNTs) were used as a conductive material. These materials were mixed in a weight ratio of cathode active material:solid electrolyte:conductivematerial:binder=85:10:3:2, using octyl acetate as a solvent, to form a slurry. The slurry was coated onto one surface of an aluminum foil cathode current collector with a thickness of 10 μm. The coated foil was then dried at atmospheric pressure at 70° C. for 2 hours, followed by vacuum drying at 70° C. for 7 hours to prepare the pre-cathode.

A mixture was prepared by adding 1 part by weight of styrene-butadiene rubber (SBR) binder based on 100 parts by weight of a solid electrolyte to a crystalline Li₆PS₅Cl solid electrolyte having an average particle size (D50) of 3 μm. While stirring, octyl acetate was added to the mixture to form a slurry. The resulting slurry was coated onto a release film using a blade coater and dried in air at 40° C. to obtain a laminate. The obtained laminate was vacuum dried at 40° C. for 12 hours to prepare a solid electrolyte layer. A solid electrolyte layer was placed on one side of an aluminum sheet and the release film was removed to prepare a pre-solid electrolyte layer.

The pre-solid electrolyte layer was placed on the pre-cathode, and a polyimide (PI) film pressurization auxiliary layer having a thickness of 20 μm was placed on the top and bottom surfaces thereof, respectively, and roll pressed at a pressure of 3 tons per centimeter (t/cm).

After roll pressing, the aluminum sheet and the pressurization auxiliary layer were removed to prepare a pre-cathode-solid electrolyte laminate.

### Preparation of Pre-Cathode-Solid Electrolyte Laminate

A nickel (Ni) foil with a thickness of 10 μm was prepared as an anode current collector. As the anode active material, a mixture of carbon black (CB) with a primary particle diameter of about 30 nm and silver (Ag) particles with an average particle diameter of about 60 nm was prepared in a weight ratio of 3:1. 4 g of the prepared mixture was placed into a container, and 4 g of an NMP solution containing 7 wt % of PVDF binder (Kureha #9300) was added to prepare a mixed solution. NMP was then gradually added to the mixture while stirring to form a slurry. The resulting slurry was coated onto the carbon layer of the prepared anode current collector using a bar coater. The coated layer was dried at atmospheric pressure at 70° C. for 2 hours, followed by vacuum drying at 70° C. for 7 hours to prepare the pre-anode.

The pre-solid electrolyte layer was prepared in the same manner as in the preparation of the pre-cathode-solid electrolyte laminate.

The pre-solid electrolyte layer was placed on the pre-anode, and a polyimide (PI) film pressurization auxiliary layer having a thickness of 20 μm was placed on the top and bottom surfaces thereof, then roll-pressed at a pressure of 2.5 t/cm.

After roll pressing, the aluminum sheet and the pressurization auxiliary layers were removed to obtain the pre-cathode-solid electrolyte laminate.

### Preparation of All-Solid Secondary Battery

The pre-cathode-solid electrolyte laminate was placed such that its solid electrolyte layer faced the solid electrolyte layer of the pre-anode-solid electrolyte laminate, and a polyimide (PI) film pressurization auxiliary layer with a thickness of 20 μm were placed on both the top and bottom surfaces thereof, respectively, and roll-pressed at a pressure of 0.1 t/cm to prepare the all-solid secondary battery. After roll pressing, the pressurization auxiliary layer was removed.

### Examples 2 to 5

An all-solid secondary battery was prepared in the same manner as in Example 1, except that the thickness of the pressurization auxiliary layer was changed. For the pressurization auxiliary layer, reference is made to Table 1.

### Example 6

### Preparation of Pre-Cathode

LiNi_{0.8}Co_{0.15}Mn_{0.05}O₂ (NCM) coated with Li₂O—ZrO₂ (LZO) was prepared as a cathode active material. The LZO-coated cathode active material was manufactured according to the method disclosed in Korean Laid-Open Publication No. 10-2016-0064942. Li₆PS₅Cl, an argyrodite-type crystal, was prepared as a solid electrolyte (average particle size (D50)=0.5 μm, crystalline). Polytetrafluoroethylene (PTFE) binder was used as a binder. Carbon nanotubes (CNTs) were used as a conductive material. These materials were mixed in a weight ratio of cathode active material:solid electrolyte:conductivematerial:binder=85:10:3:2, using octyl acetate as the solvent, to prepare a slurry. The slurry was coated onto one surface of an aluminum foil anode current collector with a thickness of 10 μm. The coated structure was then dried at atmospheric pressure at 70° C. for 2 hours, followed by vacuum drying at 70° C. for 7 hours to obtain the pre-cathode.

### Preparation of Pre-Solid Electrolyte Layer

A mixture was prepared by adding 1 part by weight of styrene-butadiene rubber (SBR) binder based on 100 parts by weight of a solid electrolyte to a crystalline Li₆PS₅Cl solid electrolyte having an average particle size (D50) of 3 μm. Octyl acetate was added to the prepared mixture while stirring to form a slurry. The slurry was applied onto a release film using a blade coater and dried in air at 40° C. to obtain a laminate. The resulting laminate was then vacuum-dried at 40° C. for 12 hours to produce the pre-solid electrolyte layer. In the all-solid battery preparation, the pre-solid electrolyte layer was placed on the pre-anode laminate, and the release film was removed.

### Preparation of Pre-Anode

A nickel (Ni) foil with a thickness of 10 μm was prepared as an anode current collector. As the anode active material, a mixture of carbon black (CB) with a primary particle diameter of about 30 nm and silver (Ag) particles with an average particle diameter of about 60 nm was prepared in a weight ratio of 3:1. 4 g of the prepared mixture was placed into a container, and 4 g of an N-methyl-2-pyrrolidone (NMP) solution containing 7 wt % of PVDF binder (Kureha #9300) was added to prepare a mixed solution. NMP was then gradually added while stirring to form a slurry. The resulting slurry was coated onto the carbon layer of the prepared anode current collector using a bar coater, dried in air at 70° C. for 2 hours under atmospheric pressure, and then vacuum-dried at 70° C. for 7 hours to obtain the pre-anode.

### Preparation of All-Solid Secondary Battery

A pre-electrode assembly was prepared by stacking a pre-cathode, a pre-solid electrolyte layer, and a pre-anode in this order. In the pre-electrode assembly, the anode active material layer of the anode and the cathode active material layer of the cathode are each placed in contact with the solid electrolyte layer. The pre-electrode assembly was placed inside a pouch, and a vacuum laminate pack process was performed to prepare a sealed pre-electrode assembly. A polyimide (PI) film pressurization auxiliary layer having a thickness of 50 μm was placed on each of the top and bottom surfaces of the sealed pre-electrode assembly. The pouch has a multilayer structure with PET (polyethylene terephthalate) layers and aluminum layers alternately laminated.

The pre-electrode assembly with a pressurization auxiliary layer was immersed in a pressurization medium and subjected to warm isostatic pressing (WIP) at 85° C. and 500 megapascals (MPa) to prepare the all-solid secondary battery.

After the WIP process, the pressurization auxiliary layer was removed.

### Examples 7 to 10

An all-solid secondary battery was prepared in the same manner as in Example 1, except that the thickness or material of the pressurization auxiliary layer was changed. For the pressurization auxiliary layer, reference is made to Table 1.

### Comparative Example 1

An all-solid secondary battery was prepared in the same manner as in Example 1, except that the pressurization auxiliary layer was omitted.

### Comparative Example 2

An all-solid secondary battery was prepared in the same manner as in Example 6, except that the pressurization auxiliary layer was changed to an aluminum sheet having a thickness of 1 mm.

### Comparative Example 3

An all-solid secondary battery was prepared in the same manner as in Example 1, except that the pressurization auxiliary layer was omitted and a carbon coating layer was added to one surface of the cathode current collector.

The carbon coating layer was prepared by coating a composition containing 1.6 wt % of carbon nanotubes, 1.6 wt % of PVDF-HFP copolymer, and octyl acetate solvent onto one surface of an aluminum foil cathode current collector, drying in air at 70° C. for 1 hour under atmospheric pressure, and then vacuum drying at 70° C. for 7 hours. The thickness of the coating layer was 35 μm.

### Comparative Example 4

An all-solid secondary battery was prepared in the same manner as in Example 6, except that the pressurization auxiliary layer was omitted.

### Evaluation Example 1: Evaluation of Surface Roughness of the Cathode Current Collector

The surface roughness of the first surface adjacent to the cathode active material layer and the second surface opposite thereto of the all-solid secondary batteries prepared in Examples 1 to 10 and Comparative Examples 1 to 3 were measured, and the measurement results are shown in Table 1.

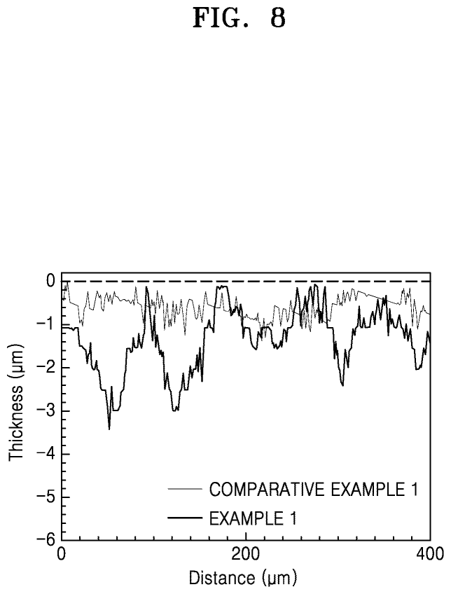

The surface roughness of the second surface was measured using an optical microscope. After measuring the surface image of the second surface using an optical microscope, a surface profile for the second surface was derived from the measured image, and the highest surface roughness value R_{y2} of the second surface was measured from this. FIG. 8 is a surface profile of the second surface of the cathode current collector of the all-solid secondary battery prepared in Example 1 and Comparative Example 1. In FIG. 8, the highest surface roughness value R_{y2} is the maximum value of the reduced thickness (i.e. depth). In FIG. 8, the y-axis represents the depth of indentation from the reference point. The x-axis represents the distance from the reference point.

As shown in FIG. 8, the cathode current collector of the all-solid battery prepared in Example 1 exhibited the higher surface roughness compared to that of Comparative Example 1.

The surface roughness of the first surface was measured from a scanning electron microscope image of a cross-section of an all-solid secondary battery.

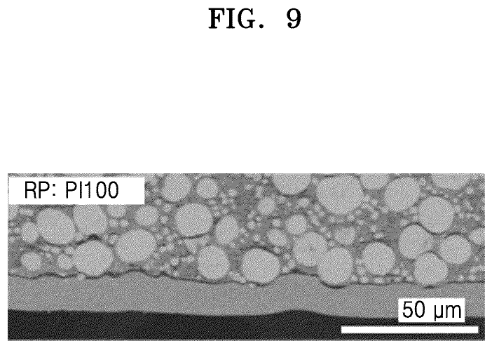

FIG. 9 is a scanning electron microscope image of a cross-section of the cathode of the all-solid secondary battery prepared in Example 4.

As shown in FIG. 9, it was confirmed that the cathode current collector of the all-solid secondary battery prepared in Example 4 had an uneven surface including a concave portion and a convex portion on the first surface and the second surface, respectively.

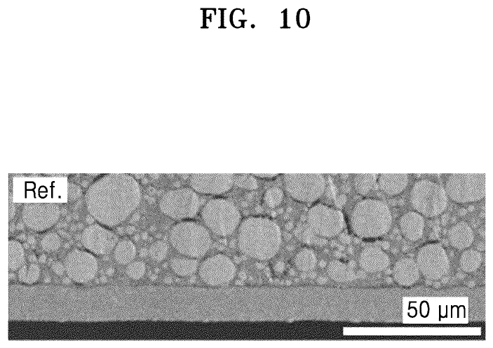

FIG. 10 is a scanning electron microscope image of a cross-section of the cathode of the all-solid secondary battery prepared in Comparative Example 1.

As shown in FIG. 10, it was confirmed that the cathode current collector of the all-solid secondary battery prepared in Example 4 did not have an uneven surface including a concave portion and a convex portion on the second surface.

In Table 1, RP refers to a roll press and WIP refers to warm isostatic press. The PET film refers to a laminated film in which 60 μm thick PET layers and 30 μm thick aluminum metal layers are laminated alternately.

TABLE 1

| | | | Highest surface | Highest surface |
|---|---|---|---|---|
| | | | roughness | roughness |
| | | | value of the | value of the |
| | Pressurization | Pressurization | second surface | first surface |
| | auxiliary layer | process | R_{y2} [μm] | R_{y1} [μm] |
| Example 1 | 20 μm thick PI film | RP | 3.5 | 3.1 |
| Example 2 | 40 μm thick PI film | RP | 4.2 | 5.1 |
| Example 3 | 50 μm thick PI film | RP | 5.7 | 6.9 |
| Example 4 | 100 μm thick PI film | RF | 5.1 | 4.5 |
| Example 5 | 200 μm thick PI film | RP | 4.1 | 3.5 |
| Example 6 | 50 μm thick PI film | WIP | 4.0 | 4.7 |
| Example 7 | 100 μm thick PI film | WIP | 4.6 | 5.4 |
| Example 8 | PI film 500 μm thick | WIP | 3.8 | 3.2 |
| Example 9 | PET film 600 μm thick | WIP | 4.0 | 4.2 |
| Example 10 | PET film 900 μm thick | WIP | 4.4 | 5.1 |
| Comparative | — | RP | 1.3 | 0.2 |
| Example 1 | | | | |
| Comparative | 1 mm thick AI sheet | WIP | 1.4 | 0.3 |
| Example 2 | | | | |
| Comparative | — | RP | 1.3 | 3.2 |
| Example 3 | | | | |

As shown in Table 1, the cathode current collectors of Examples 1 to 10 exhibited the highest surface roughness value of 1.5 μm or more on the second surface and the highest surface roughness value of 1.0 μm or more on the first surface by using a pressurization auxiliary layer.

### Evaluation Example 2: Evaluation of the Porosity of the Cathode Active Material Layer

The porosity of the cathode active material layer was evaluated by analyzing cross-sectional scanning electron microscope (SEM) images of the all-solid batteries from Example 1, Comparative Examples 1, 2, and 4. The porosity was calculated from the following Equation 1:

$$Porosity = [ Pore Area / Total Area of Cathode Active Material Layer ] \times 100. \qquad Equation 1$$

The measurement results are shown in Table 2 below.

TABLE 2

| | Pressurization | Pressurization | Porosity |
|---|---|---|---|
| | auxiliary layer | process | [%] |
| Example 1 | 20 μm thick PI film | RP | 11 |
| Comparative Example 1 | — | RP | 17 |
| Comparative Example 2 | 1 mm thick AI sheet | WIP | 4.3 |
| Comparative Example 4 | — | WIP | 9.2 |

As shown in Table 2, Example 1 and Comparative Example 2, which were pressurized using a pressurization auxiliary layer, each had a reduced porosity compared to Comparative Example 1 and Comparative Example 4, which did not have a pressurization auxiliary layer.

In addition, it was confirmed that as the porosity decreased, the ionic conductivity of the cathode active material layer of Example 1 increased compared to the ionic conductivity of the cathode active material layer of Comparative Example 1.

### Evaluation Example 3: Measurement of Charge/Discharge Characteristics (I)

The charge/discharge characteristics of the all-solid secondary batteries prepared in Examples 1 to 10 and Comparative Examples 1 to 3 were measured while being pressurized using a pressurizing jig. A pressurization jig consists of a pair of pressing plates. The all-solid secondary battery was placed between a pair of pressurization plates, and the gap between the pressurization plates was reduced to pressurize the all-solid secondary battery.

For the all-solid secondary batteries prepared in Examples 1 to 10 and Comparative Examples 1 to 3, constant current charging was performed at 45° C. with a constant current of 0.1 C until the voltage reached 4.5 V (vs. Li), and then cut-off was performed at a current of 0.02 C rate while maintaining 4.5 V in constant voltage mode. Subsequently, the discharge was performed at a constant current of 0.1 coulomb (C) rate until the voltage reached 2.5 V (vs. Li) during discharge. (Cycle 1).

The lithium battery that had undergone the first cycle was charged under constant current at a current of 0.33 C rate at 25° C. until the voltage reached 4.5 V (vs. Li), and then cut-off was performed at a current of 0.02 C rate while maintaining 4.5 V in constant voltage mode. Subsequently, the discharge was performed at a constant current of 0.33 C rate until the voltage reached 2.5 V (vs. Li) during discharge. (Cycle 2).

The lithium battery that had undergone the second cycle was charged under constant current at 25° C. with a current of 1.0 C rate until the voltage reached 4.5 V (vs. Li), and then cut-off was performed at a current of 0.02 C rate while maintaining 4.5 V in constant voltage mode. Subsequently, the discharge was performed at a constant current of 1.0 C rate until the voltage reached 2.5 V (vs. Li) during discharge. (Cycle 3).

The results of the charge/discharge characteristic measurements are shown in Table 3 below.

The charge/discharge efficiency was calculated from the following Equation 2:

$$Equation 2$$

$$Charge / Discharge Efficiency ( \% ) = [ 3 rd Cycle Discharge Capacity / 3 rd Cycle Charge Capacity ] \times 100.$$

TABLE 3

| | Pressurization | Pressurization | 0.1 C discharge | Charge/discharge |
|---|---|---|---|---|
| | auxiliary layer | process | capacity [mAh/g] | efficiency [%] |
| Example 1 | 20 μm thick PI film | RP | 211 | 83.0 |
| Example 2 | 40 μm thick PI film | RP | 207 | 83.0 |
| Example 3 | 50 μm thick PI film | RP | 214 | 83.1 |
| Example 4 | 100 μm thick PI film | RP | 209 | 82.5 |
| Example 5 | 200 μm thick PI film | RP | 203 | 81.8 |
| Example 6 | 50 μm thick PI film | WIP | 202 | 81.9 |
| Example 7 | 100 μm thick PI film | WIP | 203 | 82.0 |
| Example 8 | 500 μm thick PI film | WIP | 201 | 81.8 |
| Example 9 | 600 μm PET film | WIP | 200 | 82.0 |
| Example 10 | 900 μm PET film | WIP | 206 | 82.1 |
| Comparative | — | RP | 187 | 79.4 |
| Example 1 | | | | |
| Comparative | 1 mm thick AI sheet | WIP | 191 | 80.4 |
| Example 2 | | | | |
| Comparative | — | RP | 181 | 80.6 |
| Example 3 | | | | |

As shown in Table 3, the all-solid secondary batteries of Examples 1 to 10 had improved discharge capacity and charge/discharge efficiency compared to the all-solid secondary batteries of Comparative Examples 1 to 3.

Although the disclosure has been described in terms of an exemplary embodiment, it is not limited thereto, and it is possible to implement the disclosure by making various modifications within the scope of the patent claims, the detailed description of the invention, and the attached drawings, and it is obvious that this also falls within the scope of the disclosure.

According to an aspect of the disclosure, it is possible to provide a novel all-solid secondary battery cathode having reduced porosity by being uniformly pressurized.

According to an aspect of the disclosure, it is possible to provide an all-solid secondary battery having reduced internal resistance and improved charge/discharge characteristics by having a cathode having reduced porosity.

According to an aspect of the disclosure, a method of preparing an all-solid secondary battery enables uniform pressurization of a cathode.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A cathode for an all-solid secondary battery, comprising:
a cathode current collector; and
a cathode active material layer comprising a solid electrolyte, on the cathode current collector,
wherein the cathode current collector comprises: a first surface adjacent to the cathode active material layer; and a second surface opposing the first surface, and
a highest surface roughness value R_{y2} of the second surface of the cathode current collector is 1.5 micrometers or more.

2. The cathode of claim 1,
wherein a highest surface roughness value R_{y1} of the first surface of the cathode current collector is 1.0 micrometers or more.

3. The cathode of claim 1,
wherein the highest surface roughness value R_{y2} of the second surface of the cathode current collector is 15% or more of a thickness of the cathode current collector.

4. The cathode of claim 1,
wherein a highest surface roughness value R_{y1} of the first surface of the cathode current collector is 5% or more of a thickness of the cathode current collector.

5. The cathode of claim 1,
wherein a highest surface roughness value R_{y1} of the first surface of the cathode current collector is greater than the highest surface roughness value R_{y2} of the second surface of the cathode current collector.

6. The cathode of claim 1,
wherein a thickness of the cathode current collector is about 2 micrometers to about 100 micrometers.

7. The cathode of claim 1,
wherein the first surface and the second surface of the cathode current collector each comprise an uneven surface including a convex portion and a concave portion.

8. The cathode of claim 1,
wherein the cathode active material layer has a cathode active material layer concave portion,
the first surface of the cathode current collector has a cathode current collector convex portion that protrudes toward the cathode active material layer corresponding to the cathode active material layer concave portion, and
the second surface of the cathode current collector has a cathode current collector concave portion that is recessed in a direction of the cathode active material layer corresponding to the cathode current collector convex portion.

9. The cathode of claim 8,
wherein a radius of curvature of a cross-section of the cathode current collector concave portion is greater than a radius of curvature of a cross-section of the cathode current collector convex portion.

10. The cathode of claim 8,
wherein a radius of curvature of a cross-section of the cathode current collector concave portion is 1000 micrometers or less.

11. The cathode of claim 1,
wherein the cathode active material layer has a cathode active material layer convex portion,
the first surface of the cathode current collector has a another cathode current collector concave portion that is recessed in a direction opposite to the cathode active material layer corresponding to the cathode active material layer convex portion,
the second surface of the cathode current collector has a another cathode current collector convex portion that protrudes in a direction opposite to the cathode active material layer corresponding to the another cathode current collector concave portion.

12. The cathode of claim 11,
wherein a radius of curvature of a cross-section of the another cathode current collector convex portion is greater than a radius of curvature of a cross-section of the another cathode current collector concave portion.

13. The cathode of claim 11,
wherein a radius of curvature of a cross-section of the another cathode current collector convex portion is 1000 micrometers or less.

14. An all-solid secondary battery comprising:
the cathode of claim 1;
an anode; and
a solid electrolyte layer between the cathode and the anode.

15. The all-solid secondary battery of claim 14,
wherein the solid electrolyte layer comprises: a first solid electrolyte layer adjacent to the cathode; and a second solid electrolyte layer adjacent to the anode, and
a porosity of the first solid electrolyte layer is lower than a porosity of the second solid electrolyte layer.

16. A method of preparing an all-solid secondary battery, the method comprising:
applying a first pressurization to a cathode and a solid electrolyte layer together with a first pressurization auxiliary layer, to prepare a cathode-solid electrolyte layer laminate; and
applying a second pressurization to the cathode-solid electrolyte layer laminate and an anode-solid electrolyte layer laminate together with a second pressurization auxiliary layer, to prepare the all-solid secondary battery.

17. The method of claim 16,
wherein the first pressurization auxiliary layer and the second pressurization auxiliary layer independently comprise a polymer, a metal, a wood, or a combination thereof,
the polymer comprises polyimide, polyethylene terephthalate, polytetrafluoroethylene, polystyrene, polycarbonate, polyvinyl chloride, polyvinyl alcohol, polyacrylate, polyethylene, polypropylene, polystyrene, polyisisobutylene, polyvinyl chloride, vinyl acetate resin, polytetrafluoroethylene, polyacrylonitrile, poly(methyl acrylate), poly(methyl methacrylate), polyester, a polyester-cotton blend, nylon, a phenolic resin, urea resin, polysiloxane or a combination thereof, and
the metal comprises a metal belonging to groups 2 to 16 of the periodic table of elements.

18. The method of claim 16,
wherein the cathode comprises a cathode current collector, wherein a thickness of the first pressurization auxiliary layer and the second pressurization auxiliary layer is greater than a thickness of the cathode current collector, and
the thickness of the first pressurization auxiliary layer and the second pressurization auxiliary layer is 1 millimeter or less.

19. The method of claim 16,
wherein the first pressurization and the second pressurization are independently applied by a roll press, a plate press, a warm isostatic press, a cold isostatic press, or a hot isostatic press.

20. The method of claim 16,
wherein a pressure of the first pressurization is greater than a pressure of the second pressurization, and
the pressure of the first pressurization is at least 10 times the pressure of the second pressurization.
